(19) United States
(12) Patent Application Publication
(10) Pub. No.: US 2011/0106690 A1
(43) Pub. Date: May 5, 2011

(54) PRETERM LOAN SYSTEM AND METHOD OF USING THE SAME

(76) Inventor: Jason Fisher, New York, NY (US)

(21) Appl. No.: 12/762,112

(22) Filed: Apr. 16, 2010

Related U.S. Application Data
(60) Provisional application No. 61/212,870, filed on Apr. 16, 2009.

(51) Int. Cl. G06Q 40/00

(52) U.S. Cl. 705/38

(57) ABSTRACT

Disclosed are systems, methods and computer program products, including a method performed by one or more processor-based devices. The method includes determining a financial arrangement between a lender and a borrower, to receive by the lender one or more periodic payments from the borrower over a pre-determined time period that precedes the acquisition of an unidentified asset. The payments received are used, upon identification of the asset, to pay a required down payment portion of the price of the asset. The financial arrangement includes information specifying predetermined financing attributes to be implemented at the conclusion of the pre-determined time period. The method further includes setting at the conclusion of the predetermined period the predetermined financing attributes based, at least in part, on a determination of an extent of compliance of the borrower with obligations of the financial arrangement.

### CROSS-REFERENCE TO RELATED APPLICATIONS

This application claims priority to provisional U.S. application Ser. No. 61/212,870 entitled “Preterm Loan system, Software/Hardware System and Method of Using the Same,” filed Apr. 16, 2009, the content of which is hereby incorporated by reference in its entirety.

### FIELD OF THE DISCLOSURE

The disclosure relates to computer hardware, software and a method for creating a Preterm Loan, a new type of Loan System and/or mortgage. The systems and apparatus disclosed herein include a new computer system configured to host the Preterm Loan System, measure a potential customer's creditworthiness in a novel way, the ability to create a Preterm Loan, and the ability to securitize the novel loan to trade in a secondary market as Preterm Loan Back Securities. Both hardware and software implementations are envisioned.

### BACKGROUND

The mortgage crisis of 2009 was partly induced by the overextension of loans and credits to borrowers who lacked the corresponding financial foundation to support such excess leverage. The demand for Mortgage Back Securities combined from historically low interest rates fueled an unprecedented demand for new mortgages with a short term mindset. Lenders seeking to fuel margin expansion by increasing loan volume failed to adequately assess credit risk commensurate with the additional loan volume and favored short-term subprime instruments. Beginning in 2004, the index of Median Home Prices to Mean Household Income achieved unprecedented levels at one standard deviation above the log adjusted mean. As the growth in home prices outperformed the growth in average income, the average potential borrower faces increased (i) challenges to provide a 20% down payment, (ii) unavailability of lower down payment products, (iii) likelihood of facing interest rate penalties and/or mortgage insurance requirements to secure loans for present products in the market. (iv) increased use of alternative lending products.

The state of the credit system (180 Degree Turn) adversely affects Creditworthy Borrowers: The present mortgage crisis is forcing lenders to safeguard capital and balance sheets by taking a 180 degree “risk averse” turn towards lending to only the most creditworthy customers. Lenders are limiting credit exposure all across their balance sheets. For example, many banks have indiscriminately reduced credit limits on their customers regardless of a change in customer creditworthiness. These credit changes affect the utilization rate component of the FICO formula and subsequently reduce an individual's FICO score despite any real change in creditworthiness. Additionally, FICO, the most widely used credit scoring system, lacks adaptive capabilities to regional economic conditions and thus may not reflect true default risk.

Conventional mortgage products and the mortgage application process have not evolved: The process does not favor borrowers that have less than a 20% down payment of the appraised asset value, are minority applicants, are self employed, or may not have an accurate credit rating. the current mortgage system is plagued with chronic and acute characteristics that reduce both efficiency and profitability associated with the underwriting process. A long term assumption that has not been adequately challenged is the fact that conventional mortgages traditionally require a down payment equal to 20% of the home's value. Conventional mortgages traditionally require a down payment equal to 20% of the home's value. If the down payment is less than 20%, the borrower may have to pay a private mortgage insurance premium and/or pay an interest premium on their mortgage. The housing bubble introduced an unprecedented amount of short term mortgage and subprime products that offered short term solutions for consumers but were unsustainable as they were often dependent on ultra low borrowing short term rates, reflected inflated home prices, and overlooked lending ratios such as total housing expenses to income. Currently, there are three different commonly used mortgages in the United States of America. The FHA provides insurance for the lender which is paid by the borrower. The main function of the FHA is to provide an opportunity for people to purchase homes with a small down payment. Veterans Administration (VA) mortgages are available to active duty military, veterans or veteran's surviving spouses. While the VA does not lend money, the administration provides a guarantee on the loan. The VA loan does not require a down payment and there are no prepayment penalties. Conventional mortgages traditionally require a down payment equal to 20% of the home's value. If the down payment is less than 20%, the borrower may have to pay a private mortgage insurance premium. Most commonly, conventional mortgages are either 15 or 30 years. Conventional mortgage products have evolved but do not favor borrowers that have less than 20% down payment of the appraised asset value, are self employed or may not have an accurate credit rating.

There is a need to provide ways to increase home ownership while not increasing associated default risks. The disclosure provides implementations to identify potentially reduce risk for the bank while also providing activities to determine the creditworthiness of the borrower. The systems disclosed herein potentially provide additional long term savings for the borrower and interest income for the lender.

A Proliferation of Short Term and Subprime Products to Borrowers without Long Term Vision: Home values have plummeted as excess supply builds against demand that is being restricted by this risk-averse lending environment. In retrospect, average home prices more than doubled between 1997 and 2005 contributing to a massive temporal flux in the housing market (See Appendix A1 for contributing factors). To finance this boom, borrowers were offered a variety of short term debt options (3-7 year ARMS) at unprecedented levels. In addition, sub-prime products with large fee and private mortgage insurance requirements became readily accessible to borrowers deemed unqualified for conventional mortgages (See minority impact below). These products have effectively evaporated in the present lending environment. Moreover, lenders have reduced their offering of conventional mortgages. As a result, perfectly normal borrowers must meet stricter lending standards or face disqualification from the lending market.

Qualified Applicants receive unfavorable terms: Many lenders pushed subprime mortgages on borrowers who were qualified for conventional non-subprime mortgages. In, fact, the Wall Street Journal reported in 2006 that 61% of all borrowers receiving subprime mortgages had credit scores high enough to qualify for prime conventional loans.

Double Negative Impact on Minorities: Minority applicants are doubly impacted by today's present lending standards. First, lending has effectively evaporated for all but the most creditworthy customers, a pool that largely excludes minorities. Secondly, qualified borrowing minorities often do not receive competitive terms on loan products. Even during the mortgage boom between 1997 and 2005, minorities often failed to receive attractively priced loan products, such as conventional mortgages at competitive rates despite being qualified to receive a conventional non-subprime loan. The 2005 Home Mortgage Disclosure Act (HMDA) data show that over half of African-American borrowers, 46% of Hispanic borrowers and 17% of whites were given high cost subprime loans. According to the Federal Reserve, borrower-related characteristics such as income could explain only about 20% of this disturbing difference. In addition, the Center for Responsible Lending analyzed data in May 2006 submitted by mortgage lenders for loans made in 2004 to assess the effects of race and ethnicity on mortgage pricing. The study indicated that, for most types of sub-prime home loans, Black and Latino families were at greater risk of receiving higher-rate loans than white borrowers, even after controlling for legitimate risk factors. The analysis showed that if two families with the same credit score received loans, one Black and one white, and were similarly qualified in every other way, the Black family had a significant chance of receiving a higher-cost loan. Indeed, a class action lawsuit has been filed recently in Baltimore, Md. by a class of Black applicants against Wells Fargo Bank alleging the bank of predatorily steering Black applicants to higher priced sub-prime products even though such applicants met credit standards for prime, borrower friendly loans.

To satisfy the thirst for the Mortgage Back Securities Market, banks increased underwriting mortgages and inappropriately moved from traditional fixed rate long-term instruments to a disproportionate amount of short term lending and subprime loans. In March 2009, The Mortgage Bankers Association (MBA) reported: “Subprime ARM loans and prime ARM loans, which include Alt-A and pay option ARMs, continue to dominate the delinquency numbers. Nationwide, 48 percent of subprime ARMs were at least one payment past due and in Florida over 60 percent of subprime ARMs were at least one payment past due.” The delinquency rate breaks the record set the previous quarter and the quarter-to-quarter jump is the also the largest according to MBA records dating back to 1972. Lenders, now more risk adverse, have inappropriately moved away from lending.

An effective lending gap has opened between ultra credit worthy borrowers with high down payment capabilities and perfectly sound borrowers who may not be compatible with the current mortgage process and products. An opportunity exists to reevaluate these borrowing pools to develop a novel yet practical long-term lending solution while using augmented credit evaluation processes to isolate and identify credit worthy customers presently discarded or mispriced by present credit evaluation systems and procedures. Responsible consumers benefit with a fair long-term loan that realizes regular income, provides flexibility, and lowers the arbitrary 20% downpayment threshold. Banks benefit from an updated process with additional revenue sources and a long-term process/product alternative that can identify and retain responsible long-term borrowers.

Creditworthiness. The average home price more than doubled between 1997 and 2005. The increased demand for housing is attributed to a few reasons. First Fannie, Frannie and the Community Reinvestment Act increased housing demands in low moderate income neighborhoods. Second, the Taxpayer Relief Act of 1997 increased the demand for higher value property by increasing the capital gains exclusion from $500,000 from $125,000 and facilitating exclusions from capital gains from rental property. Lastly, the Fed contributed to cheaper house financing as the federal funds rate hit 40 year lows of 1.25% which not only increased the number of traditional fixed mortgages but increased the role of adjustable loans as a means to finance a home. These factors contributed to substantial increases in demand and in home prices. Beginning in 2004, the index of Median Home Prices to Mean Household Income achieved unprecedented levels at one standard deviation above the log adjusted mean. As the growth in home prices have outperformed the growth in average income, the average potential borrower faces increased challenges to provide a 20% down payment and an increased likelihood of incurring interest rate penalties and/or mortgages insurance.

The Preterm mortgage system ameliorates the financial challenges of rising home costs for potential homeowners who may have adequate cash flow to maintain a mortgage but may not be able to accrue a 20% down-payment. The Preterm Mortgage System may allow the borrower to replace a subsidized down payment while minimally impacting the cumulative cost for the borrower. For that matter, the Preterm Mortgage system proves a solution for potential borrowers who are credit-worthy. The Preterm Payments act as a means to prove creditworthiness of the borrower. In addition, the Conduit Payments provide an additional means of proving creditworthiness.

### SUMMARY

The proprietary “Pre Term Loan System” (PTLS) disclosed herein aims to capitalize on the opportunity created in today's lending climate by assisting underserved prospective homeowners overcome the stringent demands of today's residential mortgage market. The PTLS product effectively creates a “pre down payment vehicle” whereby a potential borrower funds a down payment account each month for a specified number of years prior to closing or identification of the asset. The ability of the potential borrower to make timely and consistent preterm and housing payments during the preterm period provides an excellent indication of a consumer's creditworthiness. Ultimately, PTLS will originate a pool of hyper-creditworthy borrowers highly attractive to traditional lenders seeking to reduce loan default risk. Loans originated will be cheaper, more profitable and less risky for all concerned parties. The disclosed model provides implementations to identify and potentially reduce risk for the bank while also providing activities to determine the creditworthiness of the borrower. The disclosed system potentially provides additional long term savings for the borrower and interest income for the lender. PTLS will effectively increase rates of home ownership without raising associated default risk.

Mortgages banks rely on two primary sources of revenue from loan origination fees and loan servicing fees (provided they are a loan servicer). Many mortgage banks sell the mortgages in the secondary market shortly after closing and therefore do not service the loans they originate but are compensated with a service release premium. The secondary market investor who purchases the loan will earn revenue via loan servicing for each month the loan is kept by the borrower. The Preterm Mortgage System provides additional sources of revenue via the Preterm mortgage period. The bank in the system earns additional interest income via the potential borrower's regular Preterm payments prior to closing or during the Preterm Period. The amount and duration of the Preterm payments are calculated by the Preterm Loan System based on input from the potential borrower and external factors such as interest rates. The Preterm Payments offers long term savings for the borrower and a means to reduce the costs coupled with the less than 20% downpayment such as finance charges, the penalties of PMI and/or interest rate penalties. The Preterm Payment concept is innovative in the sense that it provides marginal cost to the borrower when calculating the net present value. The fourth source of revenue results from the “conduit system”, a subsystem where the lender becomes the intermediary for the borrower's regular payments. The financial institution may require or offer to act as the middle man for the potential borrower's regular payments (such as rent). In this example, the rent payment would be transferred from the borrower to the financial institution and the financial institution would subsequently make the regular payments. The conduit system in this case provides interest income as well as supports the potential borrower's

The disclosure provides a system for creating a novel type of lending and credit rating system. Both hardware and software implementations are envisioned. The Preterm Loan System, is a system that monitors market interest rates, current mortgage broker bids (housed by the Preterm Loan System), actual housing costs issued by a potential borrower, and customer specific inputs to create a binding contract (Preterm Contract) with a consumer and the potential lender for an unidentified asset. Once qualified by the firm for a loan, the borrower agrees to make a series of payments (Preterm Payments) prior to identification of the asset. The terms of the preterm period (duration and payments) as well as some mortgage terms are determined within the initial Preterm contract. The contract provides the consumer with a guarantee from the firm for a mortgage provided that the consumer has delivered a series of payments during the Preterm Period. In one aspect, the firm acts as an intermediary for the consumers housing costs (such as rent or maintenance) during the Preterm period, creates a new product for secondary markets, Preterm Contracts, and provides a new way of measuring creditworthiness and also provides the borrower with an opportunity to accumulate capital towards an asset while gaining assurances to receive financing at point of identification of the asset. The system transforms the savings, credit and lending products in that it provides savings to consumers, additional bank revenue, reduced bank risk (via duration gap and interest gap) and overcomes many problems with the current credit rating systems. While the system may be applied to many different borrowers and asset types, the Preterm System is ideally suited for a borrower to purchase an asset such as a house and may be combined with a mortgage at point of closing.

The disclosure may be used towards the purchase of any asset such as, but not limited to, real estate or an automobile. The disclosure can be used with a number of strategies: to analyze market rates and consumer attributes, to measure the creditworthiness of a consumer, to act as a savings vehicle for consumers in order to reduce or negate the need for a downpayment at closing, to create opportunities for potentially valuable borrowers who may be exposed to interest premia within their loan terms, to create a time/interest rate option for consumers/banks, to provide additional revenue sources to the mortgage bank, and to reduce the duration/interest gap exposure of the bank. The disclosure provides software and a method for creating a novel type of lending system. The disclosure may be used towards the purchase of any asset, such as but not limited to, real estate, a vehicle or security. The disclosure can be used with an number of strategies, to reduce or eliminate the need for a down payment at closing, to measure the creditworthiness of a consumer, to act as a savings vehicle for consumers, to create opportunities for potential valuable borrowers who may not be able to borrow money under the current mortgage system without penalty, to create an time/interest rate option for consumers and to provide additional income to mortgage bank.

The Preterm Loan System provides implementations to combine aspects of credit history, payment activity, the debt process and market analysis within a machine to provide a means of creating a multidimensional system to identify and analyze trends within lending and scoring.

In one aspect, the disclosure provides implementations to guarantee the borrower a mortgage with a predetermined interest rate, mortgage amount of life.

In one aspect, the disclosure provides implementations to guarantee a mortgage between the lender and borrower based on a Preterm Mortgage Period whereby the potential borrower makes Preterm Mortgage payments. The Preterm Mortgage Period may be prior to identification of the asset. What the present disclosure accomplishes, unlike previous systems, is to guarantee a mortgage without identification of the asset. In order to execute the agreement, the borrower must meet the lender's qualifications during the Preterm Period and ensure that potential assets meets the requirements set by the lender.

In one aspect, the disclosure provides means to replace or subsidize a down-payment at closing. In another aspect, the disclosure may provide a means for the borrower to lock an interest rate during the Preterm Mortgage period or the traditional mortgage term.

In another aspect, the Preterm Loan System may offer fixed or market interest rates for the Preterm period. In addition, the bank may offer provisions for the time extension of the Preterm period to borrowers.

In another aspect, the Preterm System may provide implementations to act as a substitute or corroborate the creditworthiness of a potential borrower. This may, for example, be used to provide additional information in addition to or as a replacement for information from the traditional credit agencies.

The Mortgage Bank may establish early withdrawal provision, prepayment penalties, appraisal values guidelines, and/or other policies during the Preterm Period or post closing.

In some implementations, a machine is provides that analyzes outside inputs such as market interest rates, consumer attributes, and internal firm constraints to create an agreement between a borrower and a lender (called a Preterm Contract) which creates a series of payments to be paid by the lender (Preterm payments) for a predetermined amount of time (Preterm Duration) prior to identification of the asset and provides a promise to the borrower for future financing of an undetermined asset with predetermined attributes. The borrower pays one or more payments in advance of closing on an asset. The attributes, logic, decision trees, and validations may be dependent on either hardware or software. Both hardware and software implementations are envisioned. In some embodiments, the machine may rely on inputs from an external market place such as a loan bidding system whereby lenders and individuals bid on future preterm contracts or preterm contracts coupled with mortgage commitments.

In some embodiments, apparatus and methods are provided which encapsulate the model of a Preterm Contract Loan System, incorporating one or more of, for example, the following hardware modules/components: a) a Central Controller Unit (see, for example, FIG. 2); b) a plurality of numerous input and output ports attached to the Central Controller Unit; c) a plurality of one or more network interfaces connected by wired or wireless means to the Central Controller Unit by means of numerous input and output ports; d) A plurality of subunit interfaces each of which respectively connect to the Central Controller Unit by means of wired or wireless modems; d1) At least a Borrower interface; d2) A plurality of one or more Lender interfaces; d3) A plurality of one or more Credit Reporting Agency interfaces; d4) A plurality of one or more Member Banks interfaces; d5) A plurality of one or more Pass-through Agent/Mediator/Point of Sale interfaces; d6) A plurality of one or more Public Records Information-Scraper Interfaces; d7) An plurality of one or interfaces to one or more remotely located databases which may contain proprietary information necessary for the Central Controller to facilitate computation necessary to the overall proper functioning of various parts of the Central Controller; e) Additionally, embedded within the Central Controller Unit proper are contained at least the following hardware components; f) At least a central processing unit (CPU); g) means of a communicative bus interface which connects the CPU to at least the following hardware components; h) A system clock; i) A RAM (Random Access Memory) unit; j) A ROM (Read-Only Memory) unit; k) An operating system; l) A dedicated Creditworthiness Detector and Processor (CDP); m) A dedicated Ideal Spot Detector and Processor (ISDP); n) A dedicated Preterm Loan Contract Generator and Processor (PTLCGP); o) A dedicated Conduit Payment Processor (CPP); and/or p) A data storage device incorporating the following databases: lender database, bidding database, market rate database.

In some embodiments, a dedicated Creditworthiness Detector and Processor (CDP) is disclosed (as also depicted, for example, in FIG. 5), and which includes one or more of, for example, the following hardware components: a) at least a microcontroller unit (MCU), or alternatively a microprocessor unit (MPU), which connects to the main system bus interface so that it may communicate by means of commands and data with the primary CPU and other peripherals on the main bus; b) an input-data-and-control-variable-buffer (IDCVB) which connects to MCU/MPU by means of an internal bus interface and which receives data externally by means the main system bus interface and/or by means of the MCU/MPU proper. The IDCVB also connects directly by means of internal bus to the Intelligent Creditworthiness Analysis Processor (ICAP), incorporated as more fully appears below; c) an analysis-output-and-creditworthiness-strength-buffer which connects to MCU/MPU by means of an internal bus interface and which transmits data externally by means the main system bus interface and/or by means of the MCU/MPU proper; d) A Comparator Unit, which compares a generated Risk Threshold against a Creditworthiness Strength of the borrow. The Comparator Unit includes at least but is not limited to an operational amplifier, a plurality of digital latches, and a digital potentiometer. The comparator unit outputs a digital voltage signal which indicates a Yes/No condition whether the prospective Preterm Loan borrower is a good risk or a bad risk, referred to as the ‘Good-Risk Interrupt line; and/or e) An analog to digital converter (ADC) which is capable of converting quantitative analog voltages from certain embodiments of a hardware-based Creditworthiness Analysis into digital data signals.

In some implementations, an Intelligent Creditworthiness Analysis Processor (ICAP) is provided that includes one or more of, for example, the following components: a) a neural network, associative memory, or perceptron; b) a Bayesian network; c) a rule-based expert system; d) Holographic Computer System; and/or e) neuro-fuzzy system.

In some variations, a dedicated Ideal-Spot Detector and Processor (ISDP) is disclosed (as also depicted, for example, in FIG. 6), which includes one or more of, for example, the following hardware components: a) at least a microprocessor unit (MPU), or alternatively a micro-controller unit (MCU), which connects the ISDP to the main system bus/interface of the Central Controller so that it may communicate with it by means of control commands and data with the primary CPU and other peripherals on the main bus; b) a RAM unit; c) a plurality of ROM and/or EEPROM units which store databases of information including but not limited to proprietary Rules of Engagement, Negotiation Rules, and equations which are necessary to the specific functions of the ISDP; d) an operating system integral to the ISDP, which may be stored in and retrieved from a removable media type or a fixed hard-drive type storage device (in some embodiments, the operating system of the ISDP is stored in and retrieved from a electronic ROM or EEPROM type device. In an alternative embodiment, the operating system of the ISDP is shared from or is integral with the Central Controller); e) a plurality of one or more memory buffers, registers, or ports which receive variables, commands, and other data from the Central Controller and from other peripherals by means of the main system bus interface; and/or f) a plurality of one or more memory buffers, registers, or ports which transmit variables, commands, and other data to the Central Controller and to other peripherals by means of the main system bus interface.

In some embodiments, a dedicated Preterm Loan Contract Generator and Processor (PTLCGP) are disclosed (as also depicted, for example, in FIG. 7), which include one or more of, for example, the following hardware components: a) at least a microprocessor unit (MPU), or alternatively a microcontroller unit (MCU), which connects the PTLCGP to the main system bus/interface of the Central Controller so that it may communicate with it by means of control commands and data with the primary CPU and other peripherals on the main bus; b) a RAM unit; c) a plurality of ROM and/or EEPROM units which store databases of information including but not limited to proprietary Preterm Loan Contract Generation application software, company logos, equations and so forth, all of which are necessary to the specific functions of the PTLCGP; d) an operating system integral to the PTLCGP, which may be stored in and retrieved from a removable media type or a fixed hard-drive type storage device. In the preferred embodiment, the operating system of the PTLCGP is stored in and retrieved from a electronic ROM or eEPROM type device. In an alternative embodiment, the operating system of the PTLCGP is shared from or is integral with the Central Controller; e) a plurality of one or more memory buffers, registers, or ports which receive variables, commands, and other data from the Central Controller and from other peripherals by means of the main system bus interface; f) a plurality of one or more memory buffers, registers, or ports which transmit variables, commands, and other data to the Central Controller and to other peripherals by means of the main system bus interface; and/or g) an Agreement Detector which may be comprised of but not limited to a three-input AND gate, several input signal lines, and an output line to the integral MPU.

In some implementations, a dedicated Conduit Payment Processor (CPP) is provided (as also depicted, for example, in FIG. 2), which includes one or more of, for example, the following hardware components: a) at least a microprocessor unit (MPU), or alternatively a microcontroller unit (MCU), which connects the Conduit Payment processor to the main system bus/interface of the Central Controller so that it may communicate with it by means of control commands and data with its primary CPU and other peripherals on the main bus; b) a RAM unit; c) a plurality of ROM and/or EEPROM units which store databases of information including but not limited to proprietary software that pertains to the ongoing and automatic processing of payments related to the Conduit Payment System of the within business model; d) an operating system integral to the CPP, which may be stored in and retrieved from a removable media type or a fixed hard-drive type storage device. In the preferred embodiment, the operating system of the CPP is stored in and retrieved from a electronic ROM or EPROM type device. In an alternative embodiment, the operating system of the CPP is shared from or is integral with the Central Controller; e) a plurality of one or more memory buffers, registers, or ports which receive variables, commands, and other data from the Central Controller and from other peripherals by means of the main system bus interface; and/or f) a plurality of one or more memory buffers, registers, or ports which transmit variables, commands, and other data to the Central Controller and to other peripherals by means of the main system bus interface.

In some implementations, a system that analyzes outside market dynamics and borrower attributes to create a novel type of contract whereby a borrower provides payments to the future lender (Preterm Payments) in advance of identification and/or closing of the asset to be used as a substitute or subsidy for a downpayment towards an asset is provided.

In some embodiments, the borrower allows the lender to act as a intermediary for additional financial transactions (Conduit Payments). The borrowers payments including Preterm payments and/or Conduit Payments may occur prior to identification of the asset to be purchased and may act as a means to contribute to the measurement of the consumers creditworthiness in order to guarantee a loan or receive financing. The credit worthiness of the borrower may be published in order to match lenders with borrowers.

In some embodiments, the Preterm Loan System are used to determine reduce interest rate exposure, duration exposure and may provide interest income to the lender.

In some embodiments, the Preterm payments prior to closing might be part of a commitment between a mortgage bank and consumer to lend money to the consumer.

In some variations, the Preterm guarantee might not be directly assigned to an asset at the point of initiation but assignable to an asset with the agreed qualities at a later date such as at the end of the Preterm period.

In some variations, the system disclosed herein translates external inputs to create a contract and corresponding financial accounts to receive conduit payments and/or preterm payments.

In some embodiments, a system that determines a borrowers creditworthiness by the loanee's ability to make payments in advance to needing a loan or mortgage is disclosed. The system may analyze external inputs to determine the maximum loan, mortgage amounts, Preterm payments, Preterm duration, and/or interest rate estimates and publish these results to foster bidding by outside lenders.

In some embodiments, the Preterm contract may act as an interest rate option or interest rate hedge to offer a means of providing a more advantageous interest rate during either the life of the Preterm mortgage or for the mortgage term itself. The Preterm Loan System may create Preterm Loans with characteristics that act as a hedge for interest rates. The Preterm Loan may provide guarantee and contract to the borrow and seller for other terms as well. In such situations, the Preterm Loan may guarantee mortgage interest rates and other terms provided that the borrower maintains the agreed upon requirements of the lender during the Preterm Period.

In some implementations, the Preterm period may be extended or shortened to allow for purchasing flexibility. The duration may include a minimum thresholds established by the lender 19. Whereby the system may also provide a means to provide a credit measurement, risk index or risk of default based on the consideration for the Preterm payments and the Conduit Payments.

In some embodiments, the systems or processes described herein may be administered as a web-based system, telephone system (such as a telemarketing system), database analysis tool, market analysis tool, or as an office administered system used to analyze one's ability to make Preterm payments, default risk level, time horizon, and/or interest rate with future mortgage needs.

In some variations, the mortgage bank or financial institution may act as a conduit for mortgage or rent payments in addition to Preterm payments during the Preterm period. The bank may elect to act as an intermediary for the borrower's regular payments during the Preterm Period (such as but not limited to mortgage payments or rent) during the Preterm Mortgage period. The conduit payments may be also used to determine or substantiate a borrower's creditworthiness.

In some implementations, the systems or processes disclosed herein may incorporate a method to act as a conduit to an individual's or entity's regular payments in order to generate interest income or provide substantiation of regular payments that my contribute to income to housing expense ratios.

In some embodiments, the Preterm Payments may be classified by factors, not limited to, but including duration, risk level, dollar volume, or interest rates. These payments may be grouped and resold in a secondary market.

In some embodiments, a method for using a system to facility a loan arrangement between at least one lender and at least one borrower is disclosed. The method includes, for example, a. inputting into a computer or input device payments such as a borrowers disposable income and determine an appropriate commitment to make regular monthly payments for a specified period of time; b. inputting into the computer an arrangement to pass through regular payments that are currently made by the borrower; c. inputting into the computer a payment identifier specifying a credit card account or checking account, the payment identifier being associated with the potential loan offer; d. outputting the conditional loan offer to the plurality of sellers after receiving the payment identifier; e. inputting an acceptance from the lender, the acceptance being responsive to the commitment to make regular monthly payments prior to closing and/or the commitment to allow the lender to pass through regular home associated costs associated with the borrower; f. providing a payment to the lender by using the payment identifier; and/or g. providing the ability to securitize preterm and mortgage cashflows for resale to the secondary market.

In some implementations, the system described herein may be used to create as a means to identify creditworthy borrowers and marry them to lenders who may be able to provide loans. In such implementations, the power of a centralized controller to field, analyze and characterize the capabilities of the borrowers and communicate these characteristics which can be efficiently accessed and analyzed by potential financial institutions. The implementations may seek to use the “conduit payment system”, traditional mortgage, loan and/or the Preterm Loan which may be part of the communication and offering to borrower's and other institutions.

The present disclosure may include a central controller, a lender interface, borrower interface, bidding market place and associated loan databases. The central controller may act as a means for analysis of inputs from borrowers, lenders and financial markets. The central controller may provide communication to potential borrower's and/or financial institutions with Preterm Loan amounts, potential mortgage amounts and terms, not limited to but including interest, conduit requirements, terms of Preterm contracts, terms of mortgage, and Preterm payments. It may also offer fixed or market rates during either the Preterm and/or mortgage period.

The software/hardware systems described herein may be used to determine a financially advantageous condition whereby the Net Present Value of Preterm Loan may be lower than that over the Net Present Value of other mortgage options. The Preterm Loan payments in this case may offset the financial penalties (such as but not limited to interest rate penalties and/or private mortgage insurance) and provide an ability to reduce the monthly loan payment at the start of closing.

The Preterm Loan is an agreement between the lender and the borrower to create a Preterm Loan Period whereby the potential borrower makes regular payments for a minimum number of years (or provides a similar payment in terms of the Net Present Value of the intended cash flows) and the financial institution subsequently guarentees a loan amount no earlier than the agreed upon date and/or agreed upon delivery of net present value of the payments.

In some embodiments, the Preterm Loan's and/or their associate loans may be used in a financial institutions Asset-Liability Management strategy. In such embodiments, the Preterm Loan Contracts may act to reduce interest gap or duration gap.

In, some variations, the Preterm Loan System may act as a source of Preterm Loan Products which may be traded on a secondary market.

In some embodiments, the Central Controller and its associated independent Processors may be completely remote to one another as such that the primary system bus interface of the Central Controller is subdivided into independent network interfaces each attaching to the independent processors by ports, such that all the integral systems of the Central Controller may remotely communicate with each other over a wired or wireless network, which includes, but is not limited to, the Internet.

The Preterm Loan System is the first hardware/software based system to provide a borrower for a loan prior to identification or without knowledge of the asset.

The apparatus and methods of the Preterm Loan System provides a contract for a borrower to provide Preterm Payments prior to the identification an asset such as a home for a minimum duration established by the borrower prior to initiation of a mortgage or closing. During the Preterm duration, the preterm loan system monitors the potential borrowers ability to make preterm payments in order to substantiate creditworthiness.

The hardware/software of the Preterm Loan System also confers a unique credit analysis ability. The combination of a neural network, expert systems, or Bayesian together with information gathered during the Preterm Loan Duration from the Conduit Payments Processor and Preterm Loan Generator provide insight into a borrowers financial ability and creditworthiness. While other systems have used neural networks (or Bayesian systems to analyze secondary data, the hardware/software system in conjunction with the innovative Preterm Loan Contract and/or Conduit Payment system to confer a unique ability to conduct real time monitoring of a potential borrower's creditworthiness. In fact, real time feed of the Preterm System provides a distinct advantage over other systems with/without neural networks in that it does not rely on secondary sources that may suffer from inaccuracies or time delays.

The underlying method of the Preterm Loan System provides a means for a potential borrower to establish a history of payment consistency and creditworthiness to the future lender. The lender in this case gains first hand information via each payment.

In one aspect, a method performed by execution of computer readable program code by one or more processor-based devices is disclosed. The method includes determining, by the one or more processor-based devices, a financial arrangement between a lender and a borrower, to receive by the lender one or more periodic payments from the borrower over a pre-determined time period that precedes the acquisition of an unidentified asset. The payments received are used, upon identification of the asset, to pay a required down payment portion of the price of the asset. The financial arrangement includes information specifying predetermined financing attributes to be implemented at the conclusion of the pre-determined time period to control terms of a loan to be made by the lender to the borrower to purchase the asset and payment obligations by the borrower to repay the loan. The method further includes setting at the conclusion of the predetermined period, by the one or more processor-based devices, the predetermined financing attributes based, at least in part, on a determination of an extent of compliance of the borrower with obligations of the financial arrangement.

Embodiments of the method include one or more of the above-described features, as well as any of the following features.

Determining the financial arrangement may includes receiving financial information relating to the borrower, and determining, at least in part based on the received financial information, one or more amounts of, for example, the one or more periodical payments, the predetermined financing attributes, and/or the pre-determined time period.

The method may further include processing, by the one or more processor-based devices, the one or more periodic payments, each of the one or more periodic payments including a preterm portion directed to an account to record a cumulative value of the corresponding preterm portion of the each of the one or more periodic payments. The cumulative value may be used to pay the required down payment at the conclusion of the pre-determined time period. The each of the one or more periodic payments further includes a conduit portion corresponding to a financial obligation of the borrower to a third party. The method may further include causing, by the one or more processor-based devices, the corresponding conduit portion of the each of the one or more periodic payments to be directed to the third party. The third party may be a landlord of the borrower, and the corresponding conduit portion of the each of the one or more periodic payments may include rent owed by the borrower to the landlord.

Determining the financial arrangement may include specifying a payment source from which amounts corresponding to the one or more periodic payments will be received.

Determining the financial arrangement may include generating a preterm contract between the borrower and the lender, the preterm contract specifying the obligations of the borrower and the predetermined financing attributes.

The predetermined financing attributes of the financial arrangement may be more favorable than financing terms for a loan offered without determining the financial arrangement between the borrower and the lender.

The method may further include determining a creditworthiness value, associated with the borrower, based, at least in part, on the borrower's ongoing record of making the one or more periodic payments, the creditworthiness value is used, at least in part, to determine the extent of compliance of the borrower with the obligations of the financial arrangement.

The method may further include determining, based at least in part on the determined extent of compliance of the borrower with the obligations of the financial arrangement, one or more of, for example, a credit measurement, a risk index, and/or a risk of default.

The method may further include generating financial instruments based on one or more of, for example, the one or more periodic payments and the predetermined financial attributes.

In another aspect, a system is disclosed. The system includes one or more processor-based devices, and a storage device coupled to the one or more processors. The storage device stores computer instructions that when executed on the one or more processor-based devices cause the one or more processor-based devices to determine a financial arrangement between a lender and a borrower, to receive by the lender one or more periodic payments from the borrower over a pre-determined time period that precedes the acquisition of an unidentified asset. The payments received are used, upon identification of the asset, to pay a required down payment portion of the price of the asset. The financial arrangement includes information specifying predetermined financing attributes to be implemented at the conclusion of the pre-determined time period to control terms of a loan to be made by the lender to the borrower to purchase the asset and payment obligations by the borrower to repay the loan. The computer instructions executed on the one or more processor-based devices further cause the one or more processor-based devices to set at the conclusion of the predetermined period the predetermined financing attributes based, at least in part, on a determination of an extent of compliance of the borrower with obligations of the financial arrangement.

Embodiments of the system include one or more of the above-described features, including the above-described features of the method.

In a further aspect, a computer program product residing on a computer readable medium is disclosed. The computer program product includes computer instructions that when executed on one or more processor-based devices cause the one or more processor-based devices to determine a financial arrangement between a lender and a borrower, to receive by the lender one or more periodic payments from the borrower over a pre-determined time period that precedes the acquisition of an unidentified asset. The payments received are used, upon identification of the asset, to pay a required down payment portion of the price of the asset. The financial arrangement includes information specifying predetermined financing attributes to be implemented at the conclusion of the pre-determined time period to control terms of a loan to be made by the lender to the borrower to purchase the asset and payment obligations by the borrower to repay the loan. The computer instructions executed on one or more processor-based devices further cause the one or more processor-based devices to set at the conclusion of the predetermined period the predetermined financing attributes based, at least in part, on a determination of an extent of compliance of the borrower with obligations of the financial arrangement.

Embodiments of the computer program product include one or more of the above-described features, including the features of the method and of the system, as well as any of the features below.

Other features and advantages of the disclosure will be apparent from the following description and claims.

### BRIEF DESCRIPTION OF THE DRAWINGS

FIG. 1 is a diagram of a Preterm Loan Machine Architecture.

FIG. 2 is a diagram of a Central Controller.

FIG. 3 is a diagram of a Lender Interface.

FIG. 4 is a diagram of a Borrower Interface.

FIG. 5 is a diagram of a Creditworthiness Detector and Processor.

FIG. 6 is a diagram of an Ideal Spot Detector.

FIG. 7 is a diagram of a Preterm Contract Generator/Processor.

FIG. 8 is a diagram of an Inter Processor Communications.

FIG. 9 is a diagram of the overall Preterm Procedure.

FIG. 10 is a flowchart of a procedure to implement determination of a financial arrangement such as a preterm financial arrangement.

FIG. 11 is a schematic diagram of an exemplary computing system.

FIG. 12 is a diagram of a business model that may be implemented as part of the methods and systems described herein.

FIG. 13 is a diagram providing a further illustration of the processes performed by the systems and methods described herein.

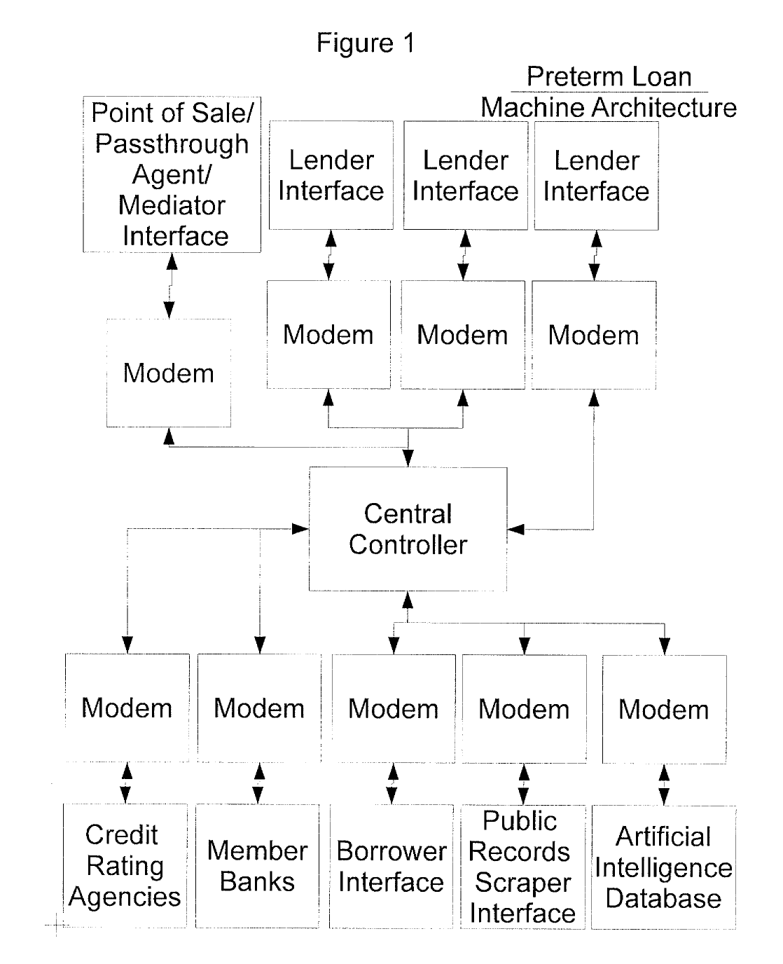

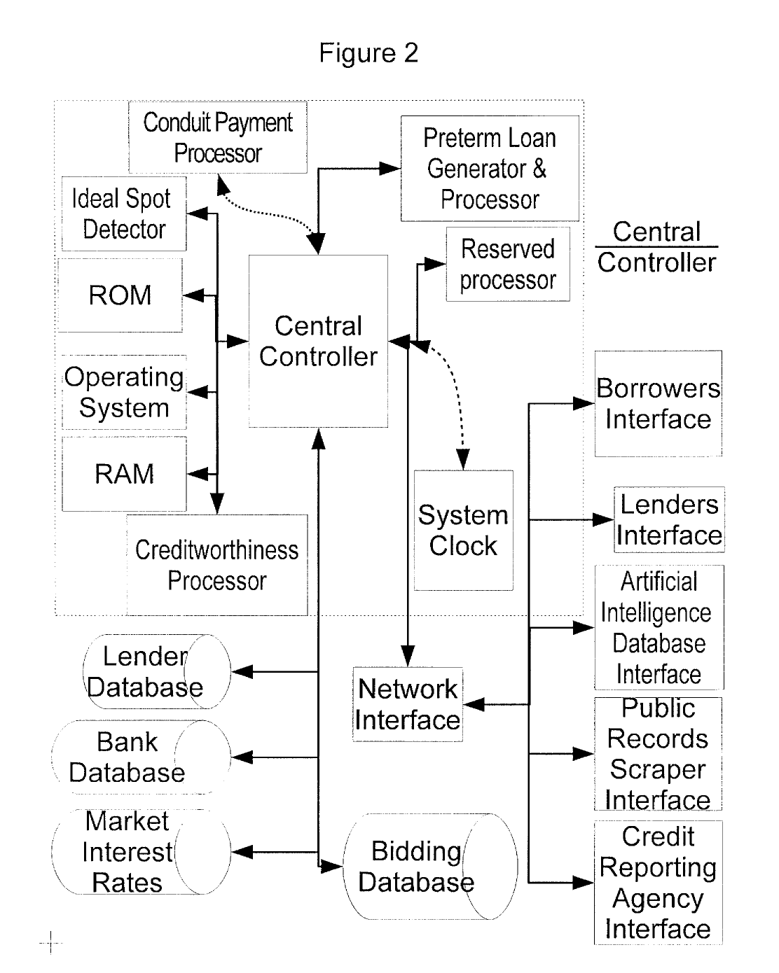

### DETAILED DESCRIPTION

The Preterm Mortgage Process and/or Hardware/Software may be administered via a computer, servers distributed on a network (such as the Internet) or in an office. The Preterm Mortgage Software may be administered via telemarketing. The Preterm Mortgage Software and/or Process may be utilized by a financial institution as a virtual bank or a traditional bank. Other types of loan instruments may be combined with the disclosure. These loan instruments may be used to help qualify the individual or corporation.

In some embodiments the Preterm Mortgage borrower may be an institution, company or individual. Reference herein to “mortgage bank” includes reference to a financial institution or any entity capable of issuing mortgages, loans or debt.

The Preterm Mortgage System relies on hardware/software to provide a financially advantageous payment arrangement to borrower's compared to the paying interest rate penalties or mortgage insurance. Both hardware and software implementations are envisioned.

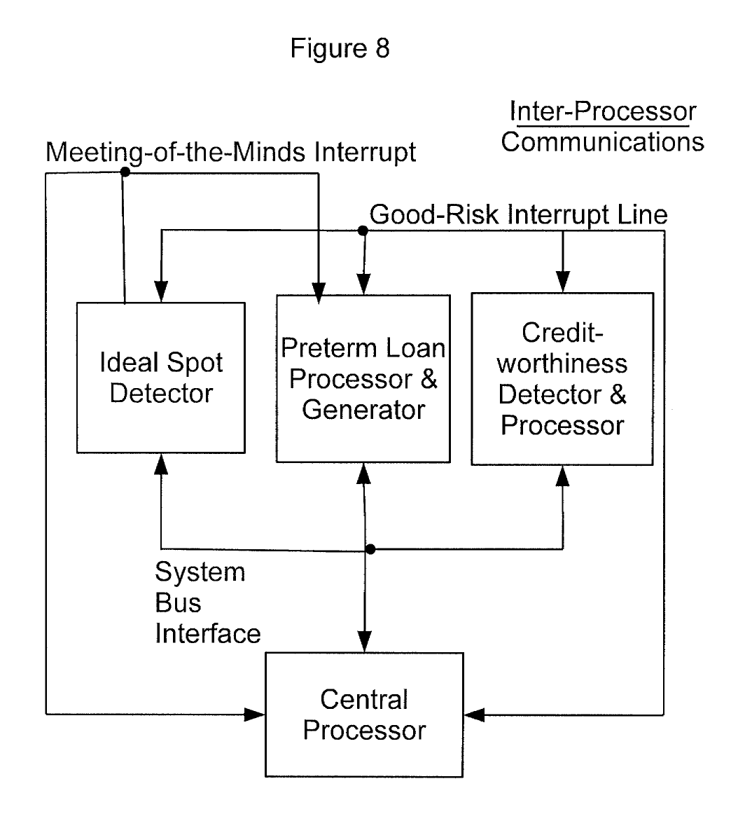

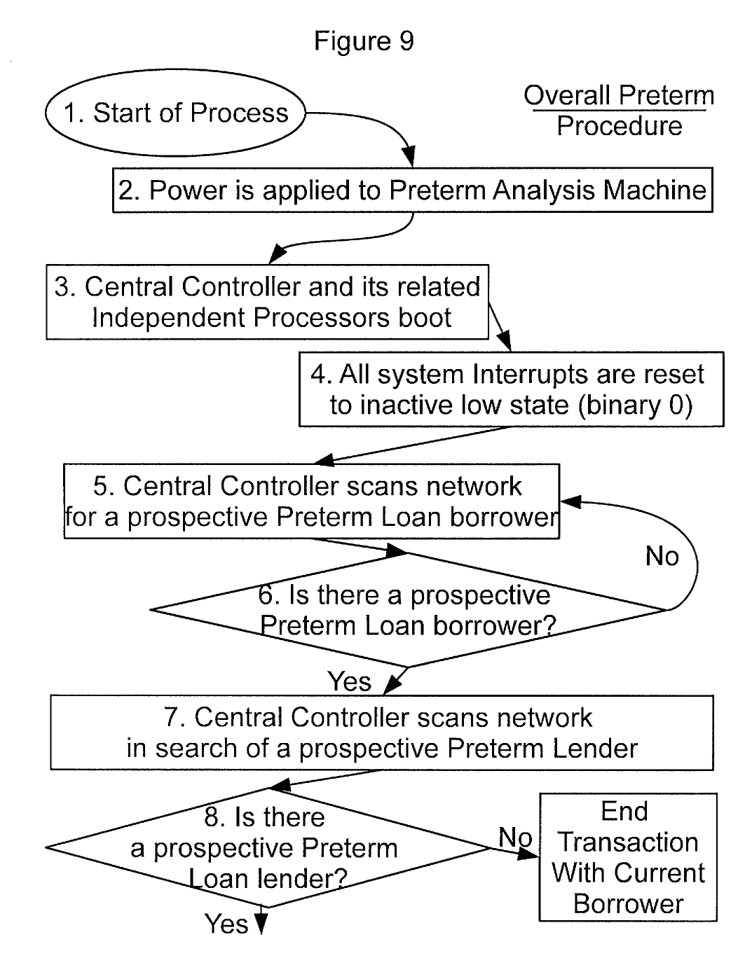

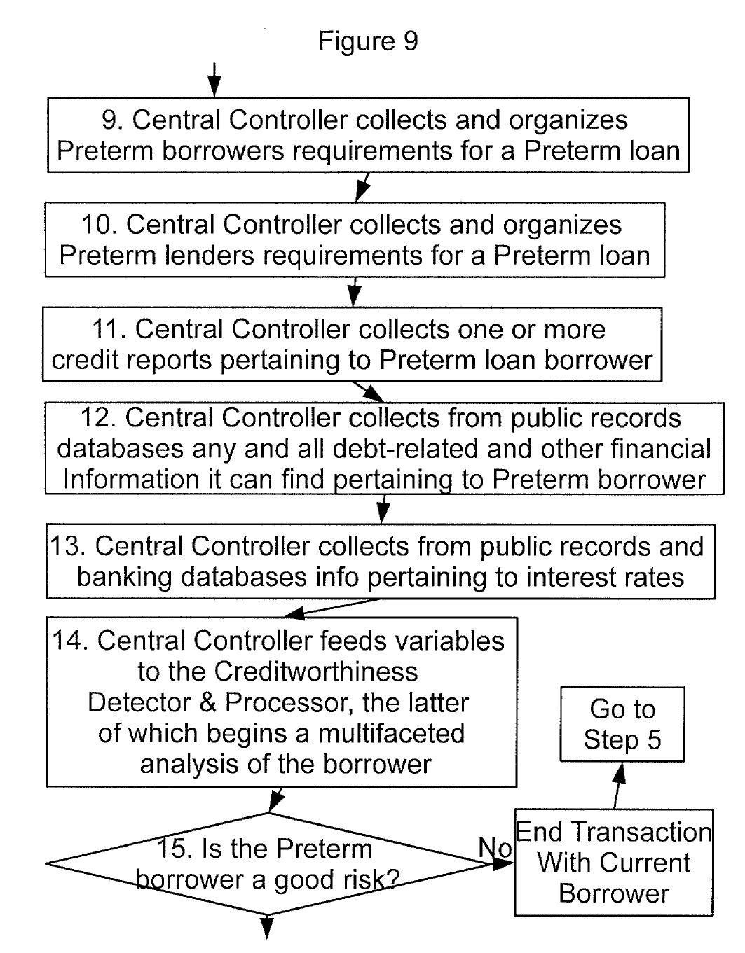

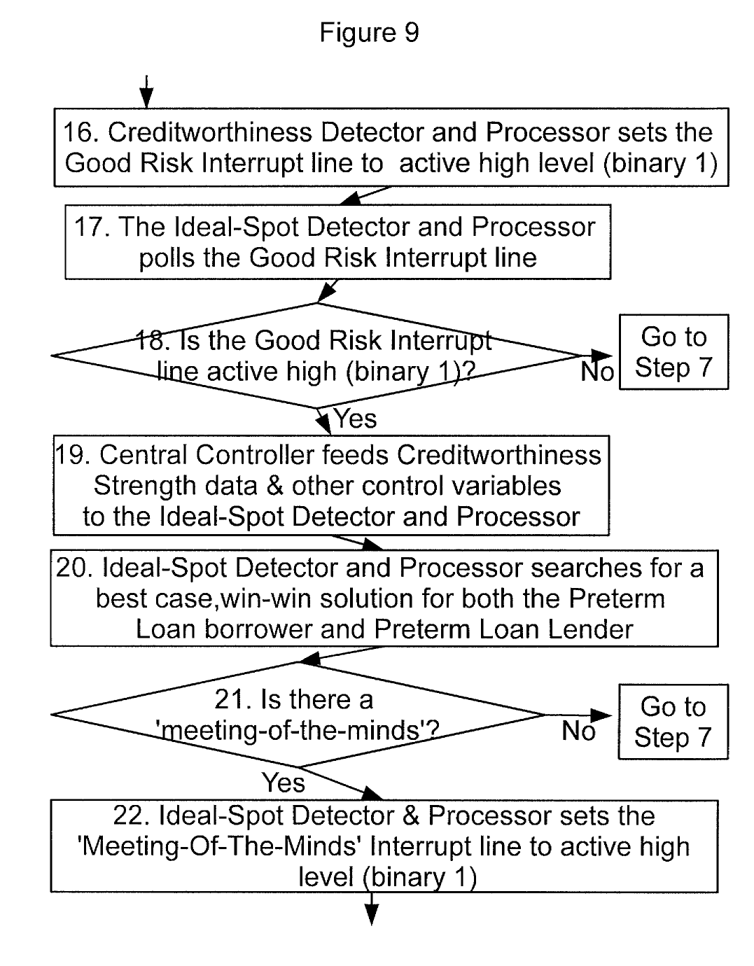

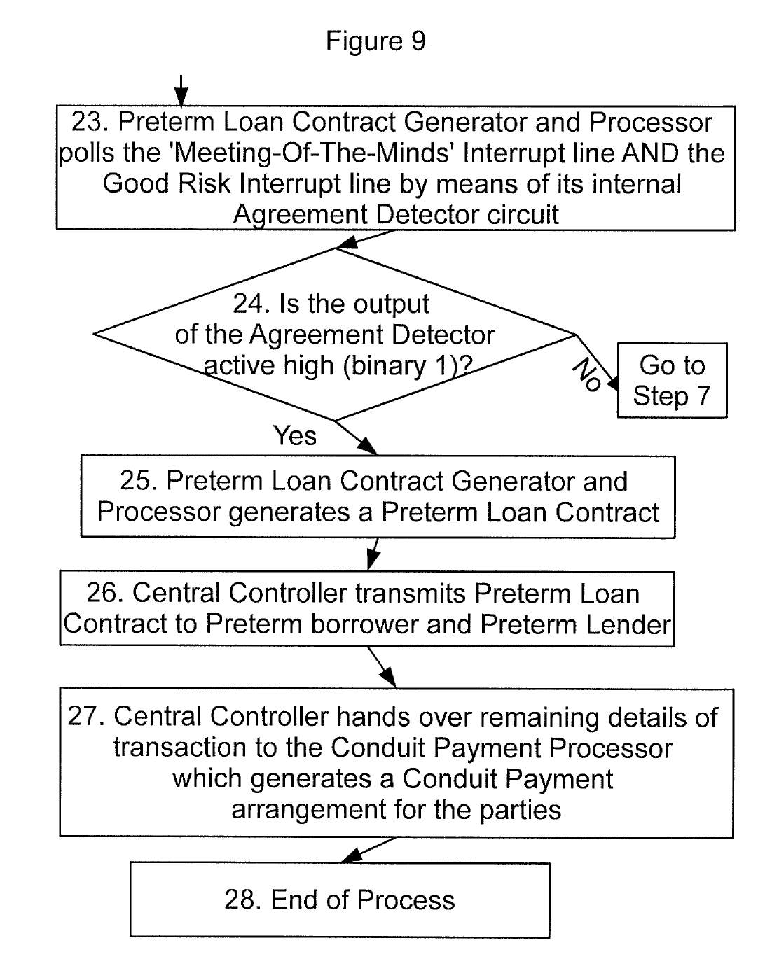

With reference to FIGS. 8 and 9, schematic diagrams of hardware embodiments of the Preterm Mortgage System that relies on a dedicated machine designed to handle interactions and processing of the aforementioned system is shown. The embodiment may include but is not limited to a Conduit Payment, Preterm Generator & Processor, Central Controller, Ideal Spot Detector, and Creditworthiness Detector and Processor.

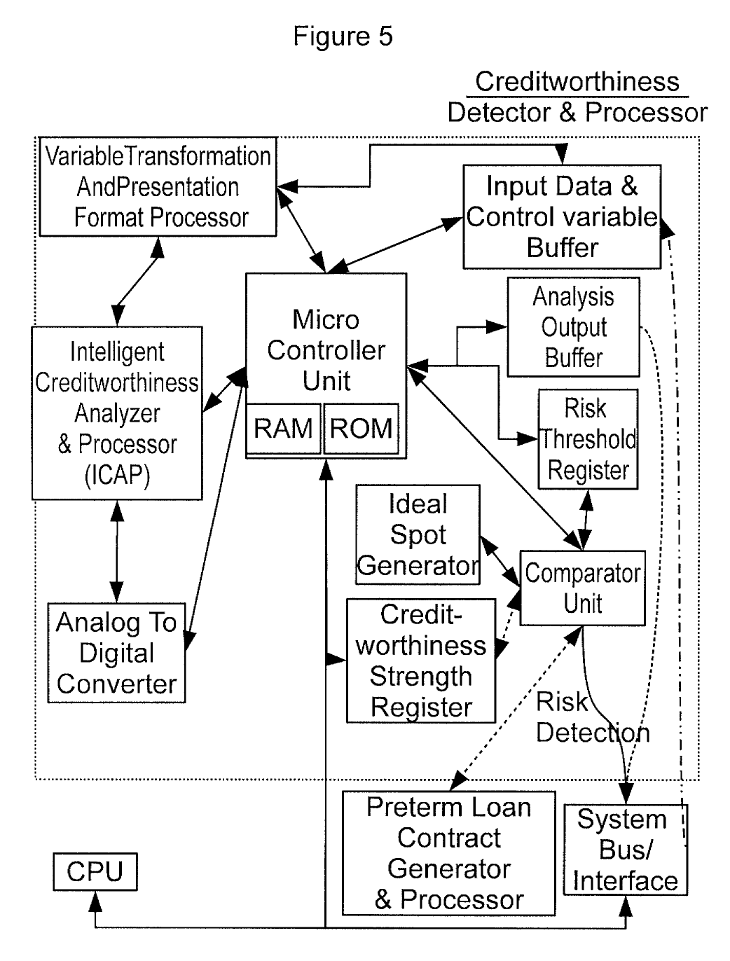

With reference to FIG. 5, a schematic diagram of a Creditworthiness Detector and Processor is shown. The Creditworthiness Detector and Processor's primary function is to analyze a prospective borrower in terms of his being a good risk or a bad risk in so far as the suitability of entering into a binding Preterm Loan Contract with a prospective lender is concerned. In some implementations, control variables related to creditworthiness are made available by using an input buffer. Other controlling variables such as interest rates, lenders terms, amount of loan sought, etc., may also be made available through the input buffer. The said control variables are transported by an internal MCU (a micro-controller unit)/MPU (microprocessor unit), or alternatively are fed directly from the input buffer, to the Variable-Transformation-And-Presentation-Format processor (VTAFP). It is the purpose of the VTAFP to transform the control variables and other input data into a format which is presentable to be properly utilized by internal components of the Intelligent Creditworthiness Analysis Processor (ICAP) which actually quantifies the borrower in terms of creditworthiness. The quantified creditworthiness is transformed, if output in a non-binary voltage level, by an analog to digital converter (ADC) which transmits the digitized level to the MCU/MPU. A threshold value is determined by the MCU/MPU based on certain of the input control variables and this threshold value is stored in, for example, a Risk Threshold Register. The Creditworthiness Strength is thus stored in the output buffer and is also stored in the Creditworthiness Strength Register. The threshold value stored and the creditworthiness strength of the borrower stored are fed to a Comparator Unit. The Comparator Unit incorporates hardware circuitry, such as an operational amplifier, which outputs a digital high voltage level if the creditworthiness level of the borrower equals or exceeds the floating threshold which was previously determined and stored in that register by the MCU/MPU. Otherwise, a digital low voltage level is output by said Comparator Unit. If a borrower is in fact determined by the CDP to be a good risk, the flag-type interrupt shown above is triggered by, for example, directly alerting other components of the system to carry out further analysis for a prospective transaction, in which case the associated output analysis and the actual corresponding strength of the borrower's creditworthiness are made available for that additional qualitative and quantitative analysis.

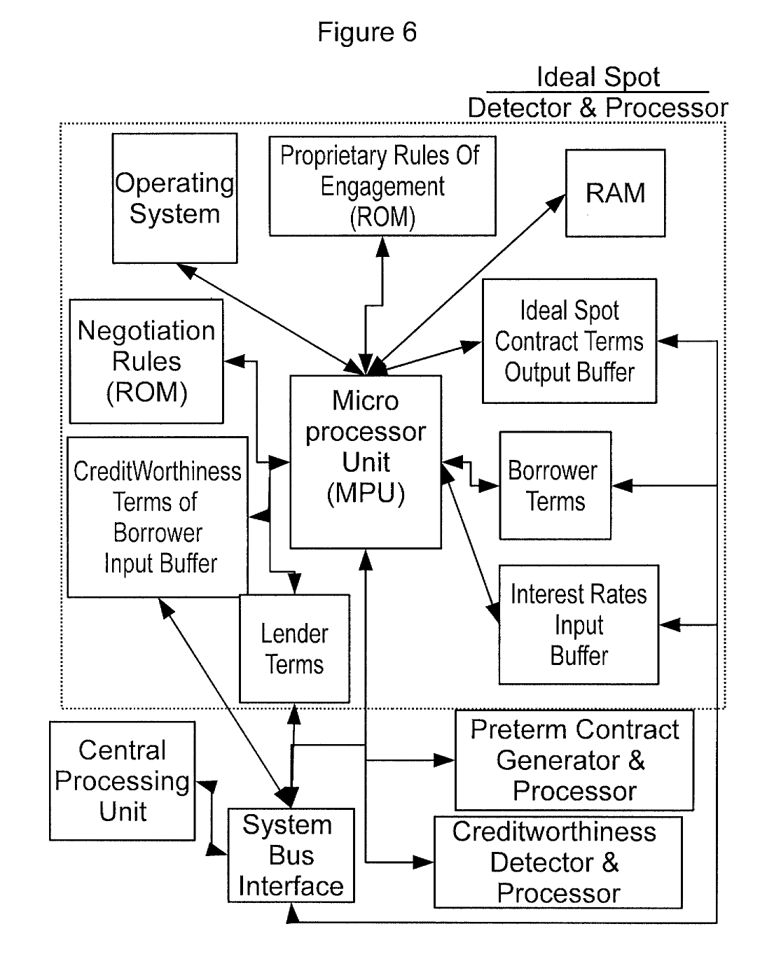

The purpose of the Ideal Spot Detector and Processor (ISDP), illustrated in FIG. 6, is to efficiently determine if a ‘meeting-of-the-minds’ between the parties seeking to enter into a binding Preterm Loan Contract is possible. The ISDP essentially processes and transforms variables and arrays of data pertinent to a Preterm Loan Contract using, for example, logic circuitry implementations, rules of engagement, and negotiation rules in order to arrive at a solution which is the most highly amenable to both the prospective lender and the prospective borrower. Some of these variables and arrays of data include but are not limited to interest rates, loan amount, borrowers terms, lenders terms, etc. These variables and arrays of data are communicated to the ISDP by an input buffer connected to the Central Controller and other peripherals using, for example, a main bus interface. Of primary importance to the function of the disclosure at large is that the ISDP integrally processes and transforms the terms of the Preterm Loan Contract by incorporating and utilizing the Creditworthiness Strength value of the prospective borrower. The Creditworthiness Strength is a value which is efficiently pre-calculated by the separate listed processor, the Creditworthiness Detector and Processor (CDP). The ISDP may be efficiently activated into operation using a Good Risk Interrupt signal line. The Good Risk Interrupt line transmits a binary voltage signal where, for example, a high or 1 indicates that the borrower is a good risk, and a low or 0 indicates a bad risk. This interrupt signal is generated by the CDP Processor and is transmitted to the ISDP by means of the system bus interface and also by means of a direct connection to the ISDP. If the said ‘meeting-of-the-minds’ is calculated such that a binding Preterm Loan Contract is warranted, the ISDP generated a high level binary voltage signal on its integral Meeting-Of-The-Minds Interrupt signal line. This line is connected to the Central Controller and other peripherals by means of the main bus interface; it is also connected directly to the separately listed processor, the ‘Preterm Loan Contract Generator and Processor, (PTLCGP), in order to activate its operation. In addition, when the ‘meeting-of-the-minds’ takes place, the ISDP copies all the necessary variables that are required to generate a Preterm Loan Contract into its contract terms output buffer.

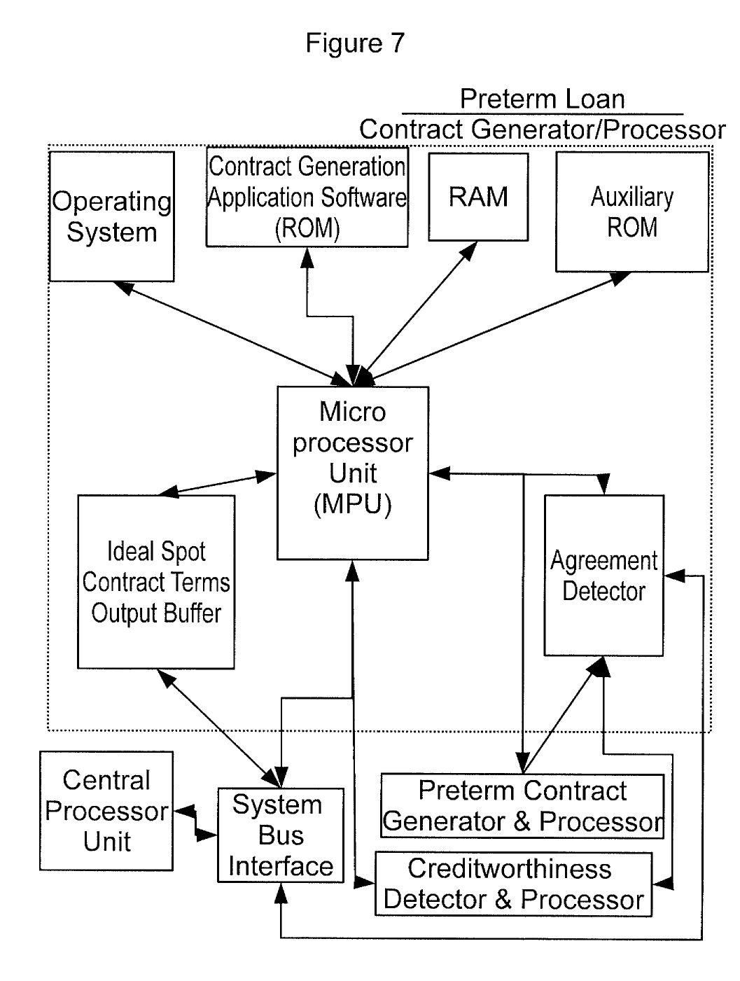

The purpose of the Preterm Loan Contract Generator and Processor (PTLCGP), shown in FIG. 7, is, in a nutshell, to generate a Preterm Loan Contract. It is activated by means of an Agreement Detector which outputs a digital signal to the PTLCGP when all of several input signals originated by the various separate processors of the system are, for example, at a high voltage level. These input signals include the Meeting-Of-The-Minds' Interrupt which is a digital signal voltage line and the Good Risk Interrupt which is also a digital signal voltage line. Also connected as an The ‘Meeting-Of-The-Minds’ interrupt is activated by the separate processor, the Ideal-Spot Detector and Processor (ISDP) when the latter has determined that a binding Preterm Loan Contract can be made between the respective parties. Correspondingly, the Good Risk Interrupt line is activated by the separate processor, the Creditworthiness Detector and Processor (CDP) when the latter has determined that the borrower is a good risk. The PTLCGP can be activated directly by the CPU of the Central Controller by a command via the main system bus interface, thus bypassing the Agreement Detector. However, the Agreement Detector is meant to be utilized as a failsafe mechanism implementation in almost all cases, and a shorting mechanism such as a switch or other embedded electronic apparatus may be implemented to prevent the CPU of the Central Controller from bypassing the Agreement Detector. The PTLCGP contains all the necessary components to generate an actual formal PTLCGP contract. These components include amongst others, Contract Generation Application Software, equations, company logos, etc. All the variables and data which are necessary to generate a contract are communicated to the PTLCGP by means of a plurality of one or more input buffers. The PTLCGP has its own RAM which is used for computation of equations and for the generation of a physically-printable, hard-copy, Preterm Loan Contract. Once the Preterm Loan Contract is generated, it is made available to the CPU of the Central Controller and other peripherals by way, for example, of the main system bus interface.

The Creditworthiness Detector and Processors, illustrated in FIG. 5, primary function is to analyze a prospective borrower in terms of his being a good risk or a bad risk in so far as the suitability of entering into a binding Preterm Loan Contract with a prospective lender is concerned. Control variables related to creditworthiness are made available by the input buffer. Other controlling variables such as interest rates, lenders terms, amount of loan sought, etc., may also be made available through the input buffer. The control variables are transported by means of the internal MCU/MPU, or alternatively are fed directly from the input buffer, to the Variable-Transformation-And-Presentation-Format processor (VTAFP). It is the purpose of the VTAFP to transform the control variables and other input data into a format which is presentable to be properly utilized by internal components of the Intelligent Creditworthiness Analysis Processor (ICAP) which actually quantifies the borrower in terms of creditworthiness. The quantified creditworthiness is transformed, if output in a non-binary voltage level, by an analog to digital converter (ADC) which transmits the digitized level to the MCU/MPU. A threshold value is determined by the MCU/MPU based on certain of the input control variables and this threshold value is stored in the Risk Threshold Register. The Creditworthiness Strength is thus stored in the output buffer and is also stored in the Creditworthiness Strength Register. The threshold value stored and the creditworthiness strength of the borrower stored are fed to a Comparator Unit. The Comparator Unit incorporates hardware circuitry, such as an operational amplifier, which outputs a digital high voltage level if the creditworthiness level of the borrower equals or exceeds the floating threshold which was previously determined and stored in that register by the MCU/MPU. Otherwise, a digital low voltage level is output by said Comparator Unit. If a borrower is in fact determined by the CDP to be a good risk, the flag-type interrupt shown above is triggered for means of directly alerting other components of the system to carry out further analysis for a prospective transaction, in which case the associated output analysis and the actual corresponding strength of the borrower's creditworthiness are made available for that additional qualitative and quantitative analysis.

The purpose of the Conduit Payment Processor (CPP) is to efficiently carry out ongoing transactions of Lenders and Borrowers who have already entered into Preterm Loan Contracts. The Conduit Payment Processor is able to access, using, for example, an embedded Direct Memory Access Controller, the various banking and payment schedule databases integral to the Central Controller so that the CPP may efficiently effectuate the routine transfer of funds, such as, but not limited to, rent, maintenance payments, association fees, or tax bills. In the preferred embodiment, the Conduit payment Processor has its own dedicated network interface and/or additional Direct Memory Access circuitry that enables it to communicate directly with the Network Interface of the Central Controller.

In some embodiments of this disclosure, a parallel processing architecture approach may be used where the separate sub-functions of each of the independent processors of this disclosure may be subdivided into workloads that are handled by numerous sub-processors working in harmony with each other so as to arrive at solutions more quickly and effectively. It is further desirable that all the sub-processors be directly addressable, e.g., using a memory-mapped type architecture, and that data be transported and communicated over network interfaces in a secure manner. One such hardware embodiment of this system may be implemented by the use of the Holoneer 1-A Holographic Computer System manufactured by the Holoneer Company. Although the Holoneer I-A prototype was generally developed for Holographic Computations, it contains an affordable architecture of over 640 individual and independent processor cores. Each of the processors that constitutes the Holoneer 1-A contains its own independent operating system, and may be easily reprogrammed for purpose of the embodiment of the Preterm Loan Contract System. The Holoneer 1-A contains independent RAM and EEPROM units, and independent network interfaces on each of its multiprocessor circuit boards. The Holoneer 1-A also claims to use a powerful holographic encryption technique; the makers of the system boast that the Holoneer 1-A would take a malevolent hacking supercomputer operating continuously at over One Trillion iterations per second over 2.5 Billion years to penetrate its outer data security defenses. Such security features would be very beneficial to protecting the sensitive financial and other data that is crucial to the operation of the Preterm Loan Contract system business model.

The borrower could use the internet, office or telemarketer to access the borrower interface. The borrower would provide information to authenticate the identity of the individual or firm and provide a financial overview. The financial overview may include, but is not limited to, the borrower's current home costs (such as rent, management fees, real estate taxes, mortgages, etc.), the income of the individual, current debt and disposable income. The input from the potential borrower would be authenticated and analyzed to provide a set of solutions for a Preterm Loan to include conditions with regard to interest (percentage, fixed, market rates) terms (minimum length or financial Net Present Value or Preterm Period) conduit payment requirements, asset requirements (such as appraisal value) and closing costs associated with the asset. Since the asset may not have been identified in the Preterm Period, the ability of the lender to establish a contractual agreement around the potential asset is critical. The establishment of the Preterm Loan is a binding contract and guarantees a mortgage to the borrower as long as the Preterm Payments are consistent during the Preterm Period, the asset meets the aforementioned requirements of the lender and the borrower's financial status continues to meet the requirements of the lender during the Preterm Period and/or mortgage period.

To provide an example, a borrower seeks a loan for $200,000 to purchase a home. In this example, a 30 year mortgage APR is 6% assuming a twenty percent down payment or $40,000 coupled with monthly payment of approximately $959. For a borrower with less than twenty percent as a down payment, the overall APR is 7% with otherwise similar terms. In this case, the borrower puts down $20,000 and is expected to pay $1198 per month. The Preterm Mortgage offers a 6.2% rate at point of closing and requires the borrower to pay $238 per month for 5 years prior to the closing of the home. Once the asset or home has been identified after five years or when the net present value of the payments has been delivered to the bank, the borrower's monthly payments are $1140, which is sixty dollars less per month than the 10% down monthly payment for the life of the loan. The bank, in this case, may use the potential borrower to use the conduit system for the borrower's rent during the Preterm period of $800. Thus, the borrower during the five years prior to a home pays approximately $1038 which includes the Preterm Payment ($238) and the regular rent payments ($800). The bank, in this case, is able to monitor payment behavior of the borrower prior to issuing the mortgage and can ascertain the creditworthiness of the individual. It is a goal of the present disclosure to find financially advantageous conditions for the buyer and the seller. The present example displays one of the capabilities of the system to identify a solution to reduce costs to the borrower. The system uses, for example, a software-based process to identify financially advantageous opportunities to create customized Preterm Loan and contracts between the lender and the borrower.
PTLS: The Pre Term Deposit (PTD) Savings Contract: A PTD Contract is executed between the PTLS provider (PTLS Participating Bank) and the PreTermer structured as follows:
Customer: The customer or “PreTermer” funds an interest bearing PTD savings account held by PTLS Participating Bank for a specified time period. For example, consider a potential customer seeking to purchase a home for $400,000. Based on traditionally applied income to asset value ratios, a mortgage banker would require that this customer have approximately $120K-140K in gross income. A comparison of mortgage scenarios at different down payment levels is as follows:

| | Conventional | Alternative | PTLS | PTLS+ |
|---|---|---|---|---|
| % down | 20% | 10% | 12% | 12% |
| Asset purchase | 400,000 | 400,000 | 400,000 | 400,000 |
| price | | | | |
| downpayment | 80,000 | 40,000 | 48,000 | 48,000 |
| Mortgage | 320,000 | 360,000 | 352,000 | 352,000 |
| Financed | | | | |
| (30 years) | | | | |
| PTD/Month | 0 | 0 | $1,000.00 | 1,000 |
| interest rate | 6.00% | 7.00% | 6.80% | 6.30% |
| Per month | ($1,918.56) | ($2,395.09) | ($2,294.78) | ($2,178.78) |
| mortgage | | | | |
| Annual | ($23,022.74) | ($28,741.07) | ($27,537.32) | ($26,145.41) |
| Mortgage | | | | |
| Yearly Savings | | | ($1,203.75) | ($1,391.91) |
| from | | | | |
| Alternative | | | | |

The above example assumes validation, logic and negotiations have occurred to support the above example as per the Preterm Contract.

Under PTLS, the PreTermer and lender would structure a contract whereby the PreTermer would be required to save a 22% of his monthly post tax income or $1000 per month in an interest bearing PTD Saving Account for 4 years to save for a down payment of approximately of 12% or $48K. This individual may also provide more capital to exceed the virtual down payment to further his/her lower mortgage payment. The actual asset to be purchased would be identified by the PreTermer during the last few months of the PTD period and meet appraisal criteria of the lender. Compared to the Alternative 10% mortgage, the PTLS originated mortgages result in substantial annual savings. We believe, at a minimum, PTLS Participating Banks would agree to finance a PTLS loan with interest rates closer to alternative products (in this case 6.8%). Substantial savings are generated for the PreTermer if PTLS+rates can be secured with the PTLS Participating Bank.
PTLS Participating Bank: In exchange, for access to this new class of borrower with, for example, an established four year track record of timely PTLS payments and housing payments, the PTLS Participating Bank would legally agree to provide the PreTermer a mortgage with an interest rate between those traditionally offered in conventional and alternative down payment products following the conclusion of the PTD period. In this case, it is assumed that PTLS Participating Bank would provide the PreTermer (in the example above) a mortgage rate of 6.80% or 6.30% with a monthly mortgage payment after closing of approximately $2300 or $2180, provided that the intended asset meets the lender's appraisal threshold.
For PreTermers: PTLS will assist PreTermers hurdle present lending restrictions that are likely to persist into the conceivable future as follows:
Down Payment Savings Vehicle: PTLS assists with down payment savings through a long term financial planning device A PreTermer's timely payment of all PTDs will serve as a first and primary measure of such customer's ability to timely fulfil all future mortgage payments (monthly pre term deposit+monthly rent=future mortgage payment). The Preterm Payments offers long term savings for the borrower and a means to reduce the costs coupled with the less than 20% down payment such as finance charges, the penalties of PMI and/or interest rate penalties.
Securing Best in Class Rates: Following the successful completion of a PTLS contract, the PreTermer will be eligible for mortgages with interest rates more attractive than lower down payment products.
For PTLS Participating Banks: The PTLS originated borrowing pool may provide PTLS Participating Banks a variety of revenue enhancing benefits as follows:
New, Less Risky Borrowing Pool: PTLS will provide for a PTLS lender a new class of less risky borrowers to ease balance sheet credit exposure in this risk adverse lending environment. In exchange for securing this new borrowing pool, a PTLS lender may be a amenable to executing PTLS Contracts obliging them to provide successful PreTermers with interest rates between conventional and alternative down payment products. Finally, a PTLS lender will be in a good position to cross sell to these customers other bank products and services.
New Funding Source: PTLS originates a new funding source (the PTDs) that can be used by a PTLS lender or be brokered to other banks as brokered deposits. Banks can earn attractive spreads by applying this new funding source (with clear duration periods) as a foundation for loans or investing it in appropriate interest producing securities. The amount and duration of the PTDs are calculated by the Preterm Mortgage Software based on input from the potential borrower and external factors such as interest rates.
The Conduit System: A key tenet of PTLS is the theory that a monthly PTD+monthly rent=a future mortgage payment. Thus a PTLS Participating Bank may employ a “conduit system”, where the lender becomes the intermediary for the borrower's regular rent payments (e.g., in situations where the ultimate asset to be purchased is a real estate asset) during the PTD Period. In this example, the rent payment would be transferred from the borrower to the financial institution and the financial institution would subsequently forward the rent payment to the landlord. The PTLS Participating Bank could essentially hold onto the rent payment for 5 days (usually the grace period for monthly rent payments) and earn short term spreads through investments in appropriate securities. The conduit system in this case provides interest income as well as supports the potential borrowers creditworthiness.

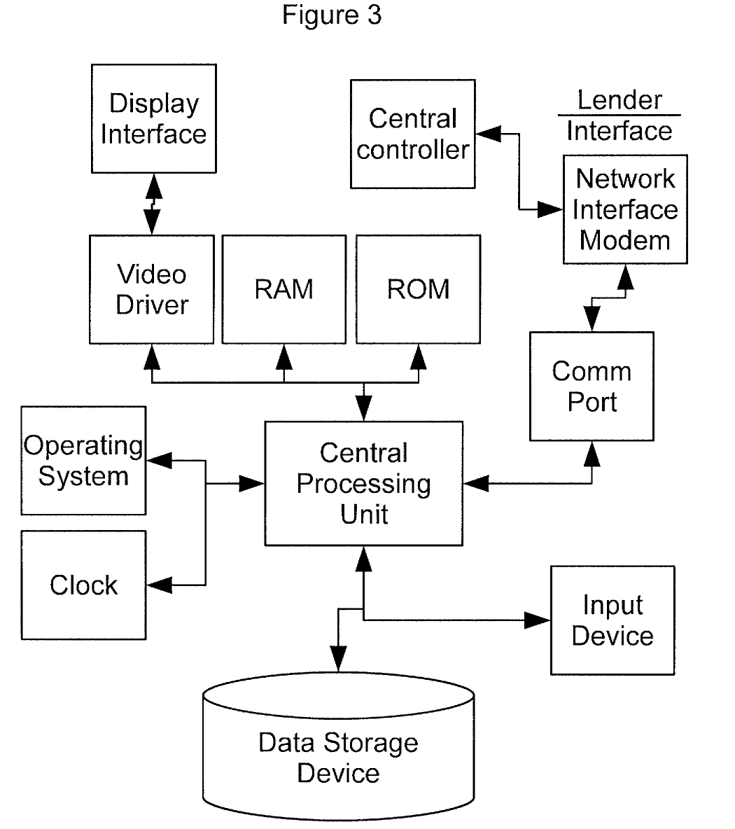

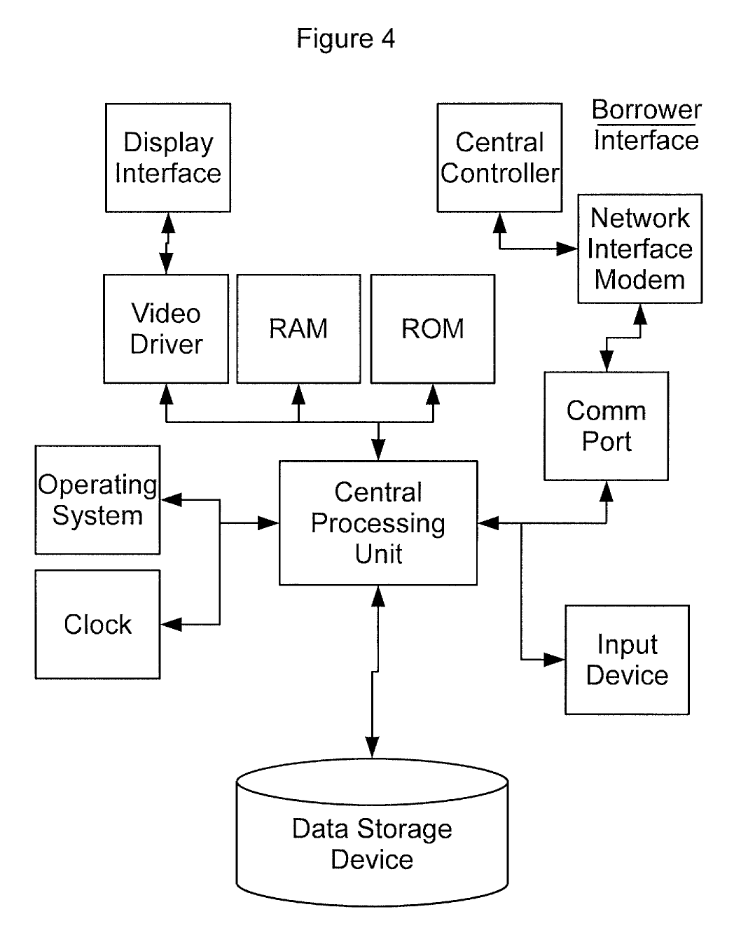

In an embodiment the present disclosure includes central controller, lender interface (as shown in FIG. 3), borrower interface (shown in FIG. 4), and associated loan databases. The central controller may be configured to perform analysis of inputs and borrowers, lenders and financial markets, etc. The central controller may provide communication to potential borrower's and/or other financial institutions with Preterm Loan amounts, potential mortgage amounts and terms, not limited to but including, interest, conduit requirements, term of the preterm, term of the mortgage, preterm payments, etc. It may also offer fixed or market rates during either the preterm and/or mortgage period.

Conduit System

In yet another aspect, the Preterm Mortgage System allows for a conduit payment system that can help substantiate a borrower's creditworthiness and generate interest income for the financial institution and/or borrower.

In some embodiments, the Mortgage Bank may require that the borrower elect the Mortgage Bank as a conduit for rent and/or mortgage payments with the borrower's current home to monitor payment activity and measure the borrower's creditworthiness.

In some embodiments, the bank may offer or require a system to serve as a conduit for payments made by the borrower, an individual, or corporation. These cash flows or conduit payments may provide benefits to the bank in terms of interest income and/or act as a means for validation of an individual's regular payments. To provide an example, the institution administering the Preterm Process may elect to act as a conduit for an individual's rent on a monthly basis to thus receive the rent from the borrower and subsequently transfer the funds to the intended recipient, such as a landlord. The bank could thus earn interest income from the funds and could also use the cash flow as a way to ascertain the ability to make timely payments. These conduit payments would contribute to the 28-36 ratios to provide a way to validate debt to income ratios. The bank may use this period to confirm that the borrower can maintain the appropriate cash flow.

In some embodiments, the Mortgage Bank or financial institution may determine a consumer's creditworthiness by the payment terms and compliance during the Preterm Period. The Mortgage bank may provide provisions or terms for late payments. The Mortgage Bank may require that the borrower's income levels and/or conduit system payments do not fall below a predetermined threshold established at the beginning of the Preterm Period.

In some embodiments, the financial institution may require a minimum amount of time for conduit payments during the Preterm Period.

### Securitization

In one aspect, the disclosure provides a basis for a market to trade tranches of all or portions of Preterm mortgages where tranches may be divided by risk, duration, volume, cashflows or loan amounts. The Preterm Mortgage combines input from the borrower with the Preterm Mortgage Software/Hardware to provide implementations to value and characterize components of the Preterm and Mortgage cashflows. In the system, the financial institution has the ability to sell Preterm securities and/or traditional mortgage securities in the secondary market.

The present disclosure provides a system to match the financial firm's requirements with borrowers capable of satisfying credit, Preterm and future asset requirements. The disclosure provides a system for creating contracts incorporating various methods of communication, commerce and security for the lender and the borrower.

The present disclosure may be used to create implementations to identify creditworthy borrowers and marry them to other financial institutions that may be able to provide loans. In some embodiments, the power of a centralized controller to field, analyze and characterize the capabilities of the borrowers and communicate these characteristics which can be efficiently accessed and analyzed by potential financial institutions. The embodiment may seek to use the “conduit payment system”, traditional mortgage, loan and/or the Preterm Loan which may be part of the communication and offering to the borrowers and other institutions.

The Preterm Loan System provides an improvement over other conventional systems since it provides improvements of measuring creditworthiness based on the actual behavior of a potential borrower and provides an improvement to mortgage and/or loan options. The Preterm Loan System would effectuate contracts between the borrower and the lender, provide a novel financial arrangement, and maintain the financial transactions associated with the Preterm and/or Loan Period. In addition, the system is configured to analyze a borrower's disposable income and/or housing expenses to make the present disclosure an improvement over conventional systems.

The Preterm Loan System provides additional flexibility for asset liability management within financial institutions and other firms. With a known forecast for preterm payments and duration during the Preterm Period, the financial institution may be able to improve the hedging against interest rate risks and/or other challenges such as duration gap. In turn, the securitize Preterm Payments offers financial institution an improved source of flexibility as they may purchase or sell Preterm securities in order to reduce the institutions risk.

With reference to FIG. 9, a diagram of an embodiment of an overall Preterm Procedure is shown, illustrating one possible execution of the Preterm Loan System. Upon boot-up the central controller and its independent processors boot as indicated in step 3. System interrupts are reset and subsequently the Central Controller scans the network for a prospective preterm Loan borrower. Upon Identification of the prospective borrower, the system scans the network for a prospective lender. As an example, the system might identify a consumer with an annual income of $140,000 in gross income.

Upon identification of a prospective lender (step 8), the central controller collects and organizes (step 9) Preterm borrower requirements for a Preterm Loan. In this example, the Lender may have certain parameters that are desirable such as borrowers with income greater than $80 k in gross pretax income and loans less than $500,000 in total value whereby the potential lender is seeking certain loan to value ratios and offering certain interest rates. The Central Controller then collects/organizes the borrower and the lender requirements and subsequently validates the potential borrower's credit history and financial status. The central controller would attain data from credit agencies, check for possible liens, and check public records to validate the customer as a Preterm candidate as indicated in steps 12 and 13.

The Central Controller now sends the appropriate data to the Creditworthiness Detector and Processor (Step 14) to conduct a further analysis of the borrower to determine the answer to step 15. The Good Risk Interrupt Line (Step 17) provides information to further refine and ensure that the lender and market conditions allow for an appropriate loan. Provided that the Good Risk Interrupt merits a continuation, the Central Controller then transmits data to the Creditworthiness Strength data and other control variables to the Ideal spot Detector to determine that the borrower, lender and market conditions allow for a suitable solution. The Ideal Spot detector (Step 20) in this example has determined that a lender is comfortable to allow for a 40 month commitment of $1500 per month to allow for a 15% cumulative downpayment towards a total asset cost of $400,000. Provided that there is a suitable solution determined as determined by the Agreement Detector in step 24, the Preterm Loan Contract Generator and Processor generates and transmits a Preterm Loan Contract to the lender and the seller.

In this illustrative example, a match between lender and borrower has been identified. This may additionally require Conduit payments of the potential borrower's current housing costs. In this example the borrower pays 1200 per month in rent. The lender would provide a Conduit payment agreement to act as the intermediary between the borrower and the borrowers landlord. The borrower's ability to make Conduit payments and preterm payments of $2700 over the course of the 40 months provides the lender real time information of the borrower's creditworthiness. An advantage of this agreement is that many lenders rely on secondary sources of information to determine creditworthiness. This system provides a new primary source of data for the lender. Additionally, the Central Controller hands over the transaction to the Conduit Payment Processor which generates a Conduit Payment arrangement to handle the borrower's other regular transactions. After completing the minimum duration as specified in the Preterm Contract, the borrower has the ability to seek an asset with a value less than $400,000 for a fixed term mortgage of 30 years. The borrower in this example is given an interest rate of 6.5% for the loan versus 6% for a 20% downpayment arrangement by the lender. Incidentally, the opportunity cost in this example shows that most lenders would offer a 7% rate for less than 20% down. The borrower would save $250 per month during the life of the mortgage for participating in the Preterm Loan System ($2150 monthly mortgage payment) versus not participating in the Preterm System with a downpayment less than 20% ($2400 monthly mortgage payment).

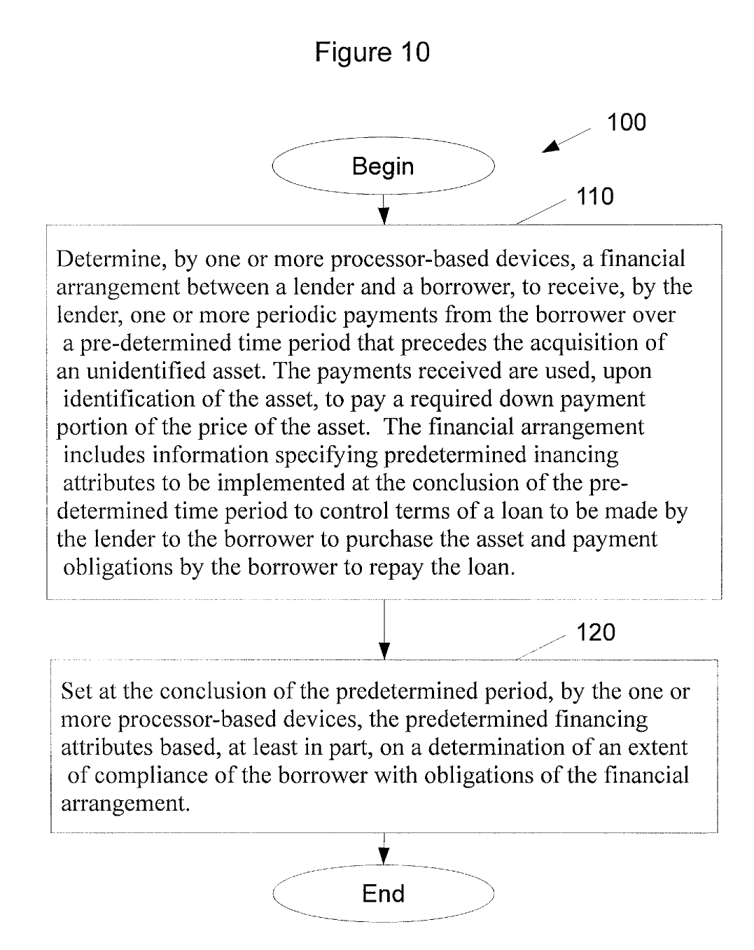

With reference now to FIG. 10, a flowchart of a procedure 100 to implement determination of a financial arrangement (such as a preterm financial arrangement described herein) is shown. The procedure may be performed by execution of computer readable program code by a processor of a computer system, or it may be performed through a dedicated circuit-based implementation. As shown, to establish a preterm contract, or some other financial arrangement, the procedure 100 includes determining, 110 by the one or more processor-based devices, a financial arrangement between a lender and a borrower. Under the financial arrangement, the lender would receive one or more periodic payments from the borrower over a pre-determined time period that precedes the acquisition of an unidentified asset. During this period, the borrower attempts to establish his/her credit worthiness and at the same time directs funds to be used as a down payment for the yet unidentified (or unknown) asset that the borrower will ultimately be able to use the funds for. Thus, the payments received from the borrower will be used, upon identification of the asset, to pay a required down payment portion of the price of the asset. The financial arrangement includes information specifying predetermined financing attributes (e.g., interest rate to be used if borrower meets all its obligation during the pre-determined period) that are to be implemented at the conclusion of the pre-determined time period to control terms of a loan to be made by the lender to the borrower to purchase the asset and payment obligations by the borrower to repay the loan.

The procedure 100 further includes setting 120 at the conclusion of the predetermined period, by the one or more processor-based devices, the predetermined financing attributes based, at least in part, on a determination of an extent of compliance of the borrower with obligations of the financial arrangement. For example, if the borrower substantially complied with all his/her obligations during the period preceding the conclusion of the pre-determined time period (e.g., the borrower timely paid in full the periodic payments), the lender will then lend the borrower the money to buy the asset, and the predetermined financial attributes specified in the preterm contract will then govern the terms and conditions of the loan.

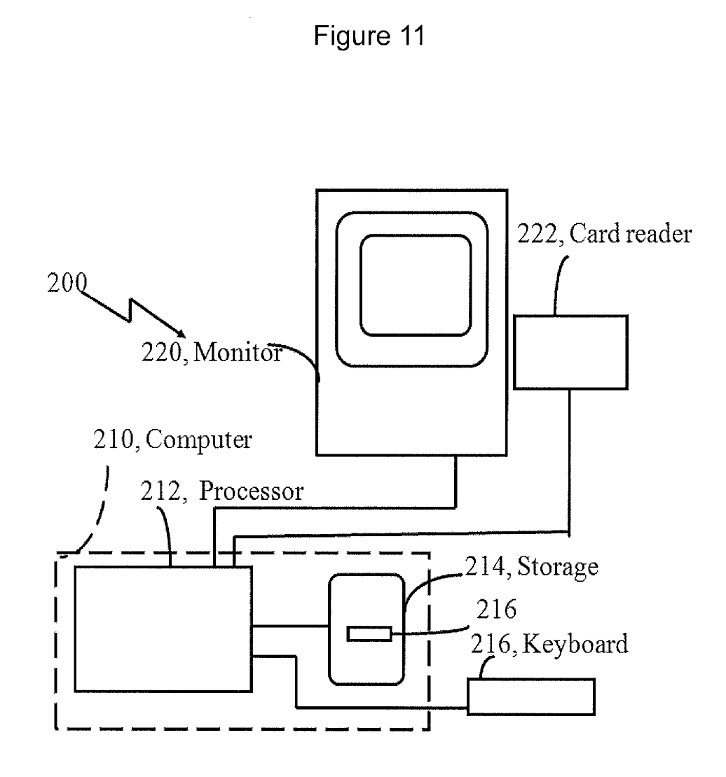

Referring to FIG. 11, a schematic diagram of an exemplary computing system 200 that could be used for implementing any of the systems/apparatus/devices/modules described herein is shown. The computing system 200 includes a processor-based device 210 such as a personal computer, a specialized computing device or a reading machine and so forth, that typically includes a central processor unit 212. In addition to the CPU 212, the system includes main memory, cache memory and bus interface circuits (not shown). The processor-based device 210 includes a mass storage element 214, here typically the hard drive associated with personal computer systems. The computing system 200 further includes a keyboard 216, a monitor 220, e.g., a CRT (cathode ray tube) or LCD (liquid crystal display) monitor. Other input devices may include a card reader 222 such as an optical or magnetic reader (scanner) to access and read data (e.g., a user's identity, a value representative of available funds the user has, etc.) stored on a card (e.g., a credit or debit card).

The processor-based device 210 is configured to facilitate, for example, the implementation of the establishment of a financial arrangement as described herein. The storage device 214 may thus include a computer program product that when executed on the processor-based device 210 performs operations to facilitate the implementation of the establishment of a financial arrangement as described herein.

The processor-based device may further include peripheral devices to enable input/output functionality. Such peripheral devices include, for example, a CD-ROM drive and/or floppy drive, or a network connection, for downloading related content to the connected system. Such peripheral devices may also be used for downloading software containing computer instructions to enable general operation of the respective system/device. Alternatively and/or additionally, in some embodiments, special purpose logic circuitry, e.g., an FPGA (field programmable gate array) or an ASIC (application specific integrated circuit) may be used in the implementation of the system 200.

Other modules that may be included with the processor-based device 210 are speakers, a sound card, a pointing device, e.g., a mouse or a trackball, by which the user can provide input to the computing system 200. The processor-based device 210 may include an operating system, e.g., Windows XP® Microsoft Corporation operating system. Alternatively, other operating systems could be used.

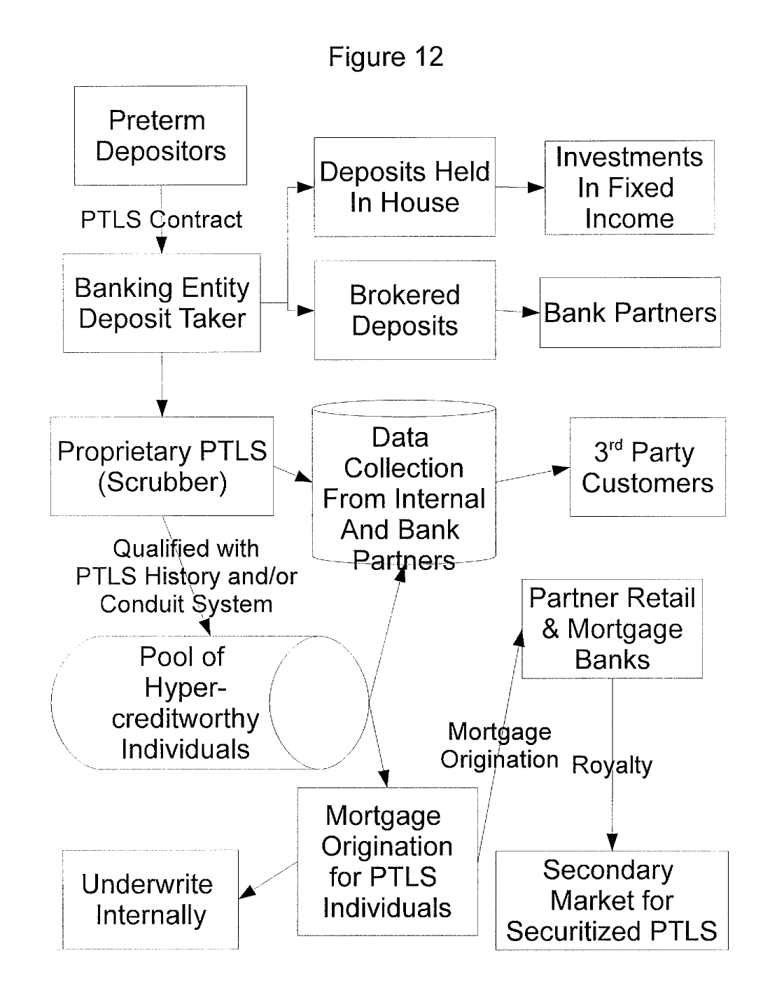

With reference to FIG. 12, a diagram of a business model that may be implemented as part of the methods and systems described herein is shown. The values referred to in FIG. 12 are by way of example only. Other values and/or implementations may be used instead.

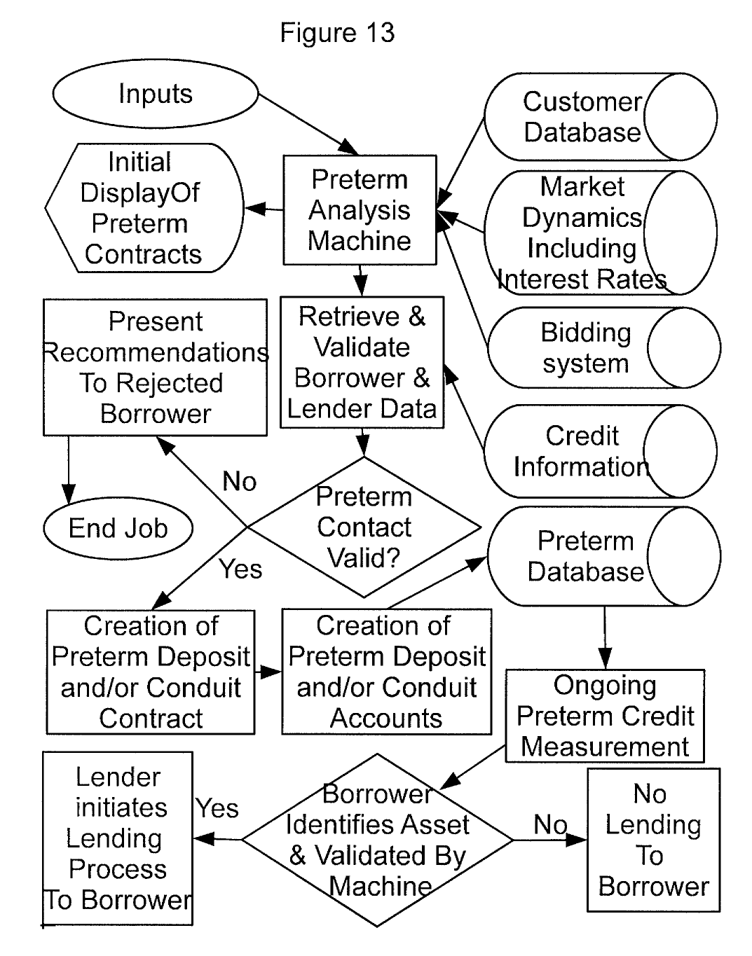

FIG. 13 provides a further illustration of the processes performed by the systems and methods described herein.

Some possible applications for the systems and methods described herein may include, for example:

(1) DeNovo Community Bank: In this case an entity could launch a denovo bank with PTLS as its differentiating product. The bank in this case could act as the lender and market the system to its borrowers.

(2) Inverse Mortgage Bank: In this case, the systems and methods described herein could be used by an entity to launch an inverse mortgage bank where (i) Preterm Loan Contracts are initiated, where deposits associated with the Preterm contract are collected and brokered to other third party banks, and (ii) the entity markets high creditworthy PTLS contracts to third party lenders in exchange for lucrative mortgage origination fees.

(3) PTLS PassThrough Agent (PPA): In this case, entities originate PTLS contracts for Participating PTLS Banks, whereby the PPA simply takes a fee for originating PTLS contracts for third party Participating PTLS Banks. Fees could be structured as (i) a percentage of deposits collected, (ii) a percentage of mortgages originated, or a combination thereof.

Unless otherwise defined, all technical and financial terms used herein have the same meaning as commonly understood by one of ordinary skill in the art to which this disclosure pertains. Although methods and material similar or equivalent to those described herein can be used in the practice or testing of the present disclosure, suitable methods and materials are described below. All publications patent applications, patents, and other references mentioned herein are incorporated by reference in their entirety. In addition, the materials methods and examples are illustrative only and not intended to be limiting.

The terms “account”, “financial account”, or “bank account” maybe used interchangeably herein and refer to means to transfer funds during the course of the Preterm Period.

The term “borrower”, “individual”, “corporation,” “entity” and institution are used interchangeably herein and refer to any subject having the potential to be a Preterm Mortgage candidate, and for whom this type of process may qualify.

“Creditworthiness” refers to the ability to make consistent “preterm” payments, mortgage and/or make consistent payments. Creditworthiness also refers to the ability to repay a financial obligation.

The terms “borrower” or “candidate” may be used interchangeably and include any individual or entity that may be a candidate or participant in the Preterm Process, including during the Preterm period or post closing of the intended asset.

The terms “Preterm Mortgage Software”, “process”, “Preterm process”, “Preterm Loan System”, and “Preterm Mortgage Process” may be used interchangeably and refer to the overall system used to, but not limited to, identify candidates, determine creditworthiness of potential borrowers, create a customized Preterm Mortgage, create a conduit payment system, classify Preterm mortgages, and allow for the securitization of the Preterm mortgages.

“Conduit payments” refer to payments whereby the bank may transfer payments from the borrower via the bank or mortgage bank to the intended recipient. Thus, the bank is an intermediary and may use the information to provide further insight into a borrower's credit status. The conduit payments may provide interest income for the bank, may help determine creditworthiness of a potential borrower, and/or may help substantiate regular payments made by the potential borrower.

The “preterm period” or “preterm duration” refers to the time prior to the identification and of the asset. The preterm period is prior to closing on the asset. The “mortgage period” begins at the closing of the asset.

Preterm Mortgage is used interchangeably with the terms Preterm Loan herein.

The terms “mortgage bank” and “bank” are used interchangeably herein. The terms “mortgage” and “loan” are used interchangeably herein.

The subject matter described herein can be implemented as one or more computer program products, i.e., one or more computer programs tangibly embodied in an information carrier, e.g., in a machine-readable storage device, for execution by, or to control the operation of, data processing apparatus, e.g., a programmable processor, a computer, or multiple computers.

A computer program (also known as a program, software, software application, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file. A program can be stored in a portion of a file that holds other programs or data, in a single file dedicated to the program in question, or in multiple coordinated files (e.g., files that store one or more modules, sub-programs, or portions of code). A computer program can be deployed to be executed on one computer or on multiple computers at one site or distributed across multiple sites and interconnected by a communication network.

Processors suitable for the execution of a computer program include, by way of example, both general and special purpose microprocessors, and any one or more processors of any kind of digital computer. Generally, a processor will receive instructions and data from a read-only memory or a random access memory or both.

The subject matter described herein can be implemented in a computing system that includes a back-end component (e.g., a data server), a middleware component (e.g., an application server), or a front-end component (e.g., a client computer having a graphical user interface or a web browser through which a user can interact with an implementation of the subject matter described herein), or any combination of such back-end, middleware, and front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other in a logical sense and typically interact through a communication network. The relationship of client and server arises by virtue of computer programs running on the respective computers and having a client-server relationship to each other.

A number of embodiments have been described. Nevertheless, it will be understood that various modifications may be made without departing from the spirit and scope of the invention. Accordingly, other embodiments are within the scope of the following claims.

What is claimed is:

1. A method performed by execution of computer readable program code by one or more processor-based devices, the method comprising:
determining, by the one or more processor-based devices, a financial arrangement between a lender and a borrower to receive by the lender one or more periodic payments from the borrower over a pre-determined time period that precedes the acquisition of an unidentified asset, the payments received being used, upon identification of the asset, to pay a required down payment portion of the price of the asset, wherein the financial arrangement includes information specifying predetermined financing attributes to be implemented at the conclusion of the pre-determined time period to control terms of a loan to be made by the lender to the borrower to purchase the asset and payment obligations by the borrower to repay the loan; and
setting at the conclusion of the predetermined period, by the one or more processor-based devices, the predetermined financing attributes based, at least in part, on a determination of an extent of compliance of the borrower with obligations of the financial arrangement.

2. The method of claim 1, wherein determining the financial arrangement comprises:
receiving financial information relating to the borrower; and
determining, at least in part based on the received financial information, one or more amounts of the one or more periodical payments, the predetermined financing attributes, and the pre-determined time period.

3. The method of claim 1, further comprising:
processing, by the one or more processor-based devices, the one or more periodic payments, each of the one or more periodic payments including a preterm portion directed to an account to record a cumulative value of the corresponding preterm portion of the each of the one or more periodic payments, the cumulative value being used to pay the required down payment at the conclusion of the pre-determined time period, the each of the one or more periodic payments further including a conduit portion corresponding to a financial obligation of the borrower to a third party;
causing, by the one or more processor-based devices, the corresponding conduit portion of the each of the one or more periodic payments to be directed to the third party.

4. The method of claim 3, wherein the third party is a landlord of the borrower, and wherein the corresponding conduit portion of the each of the one or more periodic payments includes rent owed by the borrower to the landlord.

5. The method of claim 1, wherein determining the financial arrangement comprises:
specifying a payment source from which amounts corresponding to the one or more periodic payments will be received.

6. The method of claim 1, wherein determining the financial arrangement comprises:
generating a preterm contract between the borrower and the lender, the preterm contract specifying the obligations of the borrower and the predetermined financing attributes.

7. The method of claim 1, wherein the predetermined financing attributes of the financial arrangement are more favorable than financing terms for a loan offered without determining the financial arrangement between the borrower and the lender.

8. The method of claim 1, further comprising:
determining a creditworthiness value, associated with the borrower, based, at least in part, on the borrower's ongoing record of making the one or more periodic payments, wherein the creditworthiness value is used, at least in part, to determine the extent of compliance of the borrower with the obligations of the financial arrangement.

9. The method of claim 1, further comprising:
determining, based at least in part on the determined extent of compliance of the borrower with the obligations of the financial arrangement, one or more of: a credit measurement, a risk index, and a risk of default.

10. A system comprising:
one or more processor-based devices; and
a storage device coupled to the one or more processors, the storage device storing computer instructions that when executed on the one or more processor-based devices cause the one or more processor-based devices to:
determine a financial arrangement between a lender and a borrower to receive by the lender one or more periodic payments from the borrower over a pre-determined time period that precedes the acquisition of an unidentified asset, the payments received being used, upon identification of the asset, to pay a required down payment portion of the price of the asset, wherein the financial arrangement includes information specifying predetermined financing attributes to be implemented at the conclusion of the pre-determined time period to control terms of a loan to be made by the lender to the borrower to purchase the asset and payment obligations by the borrower to repay the loan; and
set at the conclusion of the predetermined period the predetermined financing attributes based, at least in part, on a determination of an extent of compliance of the borrower with obligations of the financial arrangement.

11. The system of claim 10, wherein the computer instructions to cause the one or more processor-based devices to determine the financial arrangement comprise instructions to cause the one or more processor-based device to:
receive financial information relating to the borrower; and
determine, at least in part based on the received financial information, one or more amounts of the one or more periodical payments, the predetermined financing attributes, and the pre-determined time period.

12. The system of claim 10, wherein the computer instructions further comprise instructions to cause the one or more processor-based device to:
process the one or more periodic payments, each of the one or more periodic payments including a preterm portion directed to an account to record a cumulative value of the corresponding preterm portion of the each of the one or more periodic payments, the cumulative value being used to pay the required down payment at the conclusion of the pre-determined time period, the each of the one or more periodic payments further including a conduit portion corresponding to a financial obligation of the borrower to a third party;
cause, by the one or more processor-based devices, the corresponding conduit portion of the each of the one or more periodic payments to be directed to the third party.

13. The system of claim 12, wherein the third party is a landlord of the borrower, and wherein the corresponding conduit portion of the each of the one or more periodic payments includes rent owed by the borrower to the landlord.

14. The system of claim 10, wherein the computer instructions further comprise instructions to cause the one or more processor-based device to:
determining a creditworthiness value, associated with the borrower, based, at least in part, on the borrower's ongoing record of making the one or more periodic payments, wherein the creditworthiness value is used, at least in part, to determine the extent of compliance of the borrower with the obligations of the financial arrangement.

15. The system of claim 10, wherein the computer instructions to cause the one or more processor-based devices to determine the financial arrangement comprise instructions to cause the one or more processor-based device to:
specify a payment source from which amounts corresponding to the one or more periodic payments will be received.

16. A computer program product residing on a computer readable medium and comprising computer instructions that when executed on one or more processor-based devices cause the one or more processor-based devices to:
determine a financial arrangement between a lender and a borrower to receive by the lender one or more periodic payments from the borrower over a pre-determined time period that precedes the acquisition of an unidentified asset, the payments received being used, upon identification of the asset, to pay a required down payment portion of the price of the asset, wherein the financial arrangement includes information specifying predetermined financing attributes to be implemented at the conclusion of the pre-determined time period to control terms of a loan to be made by the lender to the borrower to purchase the asset and payment obligations by the borrower to repay the loan; and
set at the conclusion of the predetermined period the predetermined financing attributes based, at least in part, on a determination of an extent of compliance of the borrower with obligations of the financial arrangement.

17. The computer program product of claim 16, wherein the computer instructions to cause the one or more processor-based devices to determine the financial arrangement comprise instructions to cause the one or more processor-based device to:
receive financial information relating to the borrower; and
determine, at least in part based on the received financial information, one or more amounts of the one or more periodical payments, the predetermined financing attributes, and the pre-determined time period.

18. The computer program product of claim 16, wherein the computer instructions further comprise instructions to cause the one or more processor-based device to:
process the one or more periodic payments, each of the one or more periodic payments including a preterm portion directed to an account to record a cumulative value of the corresponding preterm portion of the each of the one or more periodic payments, the cumulative value being used to pay the required down payment at the conclusion of the pre-determined time period, the each of the one or more periodic payments further including a conduit portion corresponding to a financial obligation of the borrower to a third party;
cause, by the one or more processor-based devices, the corresponding conduit portion of the each of the one or more periodic payments to be directed to the third party.

19. The computer program product of claim 18, wherein the third party is a landlord of the borrower, and wherein the corresponding conduit portion of the each of the one or more periodic payments includes rent owed by the borrower to the landlord.

20. The computer program product of claim 16, wherein the computer instructions further comprise instructions to cause the one or more processor-based device to:
determining a creditworthiness value, associated with the borrower, based, at least in part, on the borrower's ongoing record of making the one or more periodic payments, wherein the creditworthiness value is used, at least in part, to determine the extent of compliance of the borrower with the obligations of the financial arrangement.

21. The method of claim 1, further comprising:
generating financial instruments based on one or more of: the one or more periodic payments and the predetermined financial attributes.
